(19) United States
(12) Patent Application Publication
(10) Pub. No.: US 2009/0298523 A1
(43) Pub. Date: Dec. 3, 2009

(54) RADIO COMMUNICATION BASE STATION APPARATUS, RADIO COMMUNICATION TERMINAL APPARATUS, AND RESOURCE BLOCK ALLOCATION METHOD

(75) Inventors: Yoshihiko Ogawa, Kanagawa (JP); Daichi Imamura, Kanagawa (JP); Kenichi Kuri, Kanagawa (JP); Sadaki Futagi, Ishikawa (JP); Atsushi Matsumoto, Ishikawa (JP); Takashi Iwai, Ishikawa (JP); Tomofumi Takata, Ishikawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/304,728

(22) PCT Filed: Jun. 14, 2007
(86) PCT No.: PCT/JP2007/061981

§ 371 Date: Dec. 12, 2008

(30) Foreign Application Priority Data
Jun. 14, 2006 (JP) 2006-164870
Aug. 8, 2006 (JP) 2006-216150
Jan. 11, 2007 (JP) 2007-003662

(51) Int. Cl. H04B 7/00

(52) U.S. Cl. 455/509

(57) ABSTRACT

Provided is a radio communication base station device capable of obtaining a large multi-user diversity effect while suppressing increase of overhead of a communication signal. The radio communication base station device includes a scheduler (101) which performs scheduling for allocating RB (Resource Block) to terminals belonging to a first group by FSA (Frequency Scheduled Allocation) in accordance with line quality of each terminal and each RB and allocating remaining RB other than the RB allocated to the terminals belonging to the first group, to terminals belonging to a second group according to a predetermined allocation rule. That is, the scheduler (101) performs RB allocation to the terminals belonging to the first group with a higher priority than RB allocation to the terminals belonging to the second group. Each time the scheduler (101) performs FSA, it outputs the result of the FSA to the terminals belonging to the first group to an encoding unit (102) and an extraction unit (111) and does not output any scheduling result to the terminals belonging to the second group.

### TECHNICAL FIELD

The present invention relates to a radio communication base station apparatus (hereinafter simply “base station”), a radio communication terminal apparatus (hereinafter simply “terminal”) and a resource block allocation method.

### BACKGROUND ART

There are two methods of for allocating resource blocks (RB) of frequency band to a terminal; (1) a method of allocating RB's through scheduling according to channel quality, that is, through frequency scheduling (frequency scheduled allocation: “FSA”); and (2) a method of allocating RB's according to predetermined allocation patterns (persistent scheduled allocation: “PSA”). An RB here refers to a block grouping several subcarriers.

According to FSA, the RB allocated to each terminal changes every time RB allocation according to the channel quality of the RB of each terminal, and, therefore, although the base station needs to report scheduling results to each terminal, it is still possible to provide substantial multiuser diversity effect.

On the other hand, according to PSA, the RB allocated to each terminal is fixed according to predetermined allocation patterns represented by transmission timings on the time domain and transmission RB's on the frequency domain, and, therefore, although multiuser diversity effect is less than FSA, the base station needs not report scheduling results to each terminal. Furthermore, according to PSA, the allocation pattern is reported in advance from the base station to terminals, so that the terminal can identify the RB allocated to the terminal through the report (see Non-Patent Document 1).

### Non-Patent Document 1: Ericsson, “Persistent Scheduling for E-UTRA”, TSG-RAN WG1 LTE AdHoc, R1-060099, Helsinki, Finland, Jan. 23-25, 2006.

### DISCLOSURE OF INVENTION

### Problems to be Solved by the Invention

Here, when a relatively wide frequency bandwidth is available, two RB allocation methods, FSA and PSA, may be used at the same time. For example, of terminals A to F with which a base station communicates simultaneously, FSA may be applied to terminals A to C and PSA may be applied to terminals D to F. In this case, since the allocation pattern in PSA is determined in advance as described above, FSA for terminals A to C needs to be performed targeting only the RB's other than the RB's subjected to PSA. That is, when FSA and PSA are used at the same time, RB's available for FSA are limited to some RB's of all available RB's. Therefore, there is a problem that the multiuser diversity effect provided by FSA is reduced.

To solve this problem, FSA may be applied to terminals A to C targeting all RB's. However, in this case, the RB's that can be allocated to terminals D to F change according to the result of FSA with respect to terminals A to C. For this reason, every time FSA is performed, the RB's allocated to terminals D to F need to be newly reported, which increases the overhead of report signals.

It is therefore an object of the present invention to provide a base station, terminal and RB allocation method capable of providing substantial multiuser diversity effect while suppressing an increase of overhead of report signals.

### Means for Solving the Problem

The base station of the present invention is a base station that allocates a plurality of RB's in a frequency domain to a plurality of terminals classified into a first group and second group, and adopts a configuration including a scheduling section that allocates RB's to terminals belonging to the first group based on first scheduling according to channel quality and then performs second scheduling to allocate remaining RB's other than the RB's allocated to terminals belonging to the first group, to terminals belonging to the second group according to predetermined allocation rules and a transmitting section that transmits the result of the first scheduling to both terminals belonging to the first group and terminals belonging to the second group but does not transmit the result of the second scheduling.

The base station according to the present invention is a base station that allocates a plurality of resource blocks in the frequency domain to a plurality of terminals classified into a first group and a second group, the plurality of resource blocks being divided into a plurality of resource block groups and adopts a configuration including a scheduling section that allocates resource blocks to terminals belonging to the first group using each resource block group as a unit, based on first scheduling according to channel quality and then performs second scheduling to allocate remaining resource blocks other than the resource blocks allocated to terminals belonging to the first group to terminals belonging to the second group using each resource block group as a unit, according to predetermined allocation rules and a transmitting section that transmits the result of the first scheduling to both terminals belonging to the first group and terminals belonging to the second group but does not transmit the result of the second scheduling.

### ADVANTAGEOUS EFFECT OF THE INVENTION

According to the present invention, it is possible to achieve substantial multiuser diversity effect while suppressing an increase of overhead of report signals.

### BRIEF DESCRIPTION OF DRAWINGS

FIG. 1 is a block diagram of a base station according to Embodiment 1 of the present invention;

FIG. 2 is a block diagram of a terminal according to Embodiment 1 of the present invention;

FIG. 3 shows RB examples according to Embodiment 1 of the present invention;

FIG. 4 shows an allocation rule table according to Embodiment 1 of the present invention;

FIG. 5A shows an example of RB allocation through FSA according to Embodiment 1 of the present invention;

FIG. 5B shows an example of RB allocation in accordance with an allocation rule according to Embodiment 1 of the present invention;

FIG. 6 shows an example of scheduling result (when scheduling is performed per subframe) according to Embodiment 1 of the present invention;

FIG. 7 shows an example of scheduling result (when scheduling is performed once every 3 subframes) according to Embodiment 1 of the present invention;

FIG. 8 shows an allocation rule table according to Embodiment 2 of the present invention;

FIG. 9 shows an example of scheduling result according to Embodiment 2 of the present invention;

FIG. 10 is an example of RBG according to Embodiment 3 of the present invention;

FIG. 11 shows an allocation rule table according to Embodiment 3 of the present invention;

FIG. 12A shows an example of RB allocation (FSA for terminal A) according to Embodiment 3 of the present invention;

FIG. 12B shows an example of RB allocation (RB allocation to terminal D according to the allocation rule) according to Embodiment 3 of the present invention;

FIG. 12C shows an example of RB allocation (FSA for terminal B) according to Embodiment 3 of the present invention;

FIG. 12D shows an example of RB allocation (RB allocation to terminal F according to the allocation rule) according to Embodiment 3 of the present invention;

FIG. 12E shows an example of RB allocation (FSA for terminal C) according to Embodiment 3 of the present invention;

FIG. 12F shows an example of RB allocation (RB allocation to terminal E according to the allocation rule) according to Embodiment 3 of the present invention;

FIG. 13 shows an example of scheduling result according to Embodiment 3 of the present invention;

FIG. 14 shows another example of scheduling result according to Embodiment 3 of the present invention;

FIG. 15 shows a further example of scheduling result according to Embodiment 3 of the present invention;

FIG. 16 shows an allocation rule table according to Embodiment 4 of the present invention;

FIG. 17 shows another allocation rule table according to Embodiment 4 of the present invention;

FIG. 18 shows another example of scheduling result according to Embodiment 4 of the present invention;

FIG. 19A shows an example of sequential order information allocation (subframes n to n+20) according to Example 1 of Embodiment 5 of the present invention;

FIG. 19B shows an example of sequential order information allocation (subframes n+21 to n+40) according to Example 1 of Embodiment 5 of the present invention;

FIG. 20 shows an example of sequential order information allocation according to Example 2 of Embodiment 5 of the present invention;

FIG. 21A shows an example of sequential order information allocation (subframe n) according to Example 3 of Embodiment 5 of the present invention;

FIG. 21B shows an example of sequential order information allocation (subframe n+1) according to Example 3 of Embodiment 5 of the present invention;

FIG. 21C shows an example of sequential order information allocation (subframe n+2) according to Example 3 of Embodiment 5 of the present invention;

FIG. 22A shows an example of sequential order information allocation (subframe n) according to Example 4 of Embodiment 5 of the present invention;

FIG. 22B shows an example of sequential order information allocation (subframe n+1) according to Example 4 of Embodiment 5 of the present invention;

FIG. 22C shows an example of sequential order information allocation (subframe n+2) according to Example 4 of Embodiment 5 of the present invention;

FIG. 23 shows an example of sequential order information allocation according to Embodiment 6 of the present invention;

FIG. 24 is a block diagram of a base station according to Embodiment 7 of the present invention;

FIG. 25 is a block diagram of a terminal according to Embodiment 7 of the present invention;

FIG. 26 shows a relationship between control information and data when the present invention is applied to uplink RB allocation;

FIG. 27 shows a relationship between control information and data when the present invention is applied to downlink RB allocation;

FIG. 28 shows RB allocation candidates determined by sequential order information according to Embodiment 7 of the present invention;

FIG. 29 shows RB allocation candidates determined by an FSA result according to Embodiment 7 of the present invention;

FIG. 30 shows an example of RB allocation (case of one terminal) according to Embodiment 8 of the present invention;

FIG. 31 shows an example of RB allocation (case of two terminals) according to Embodiment 8 of the present invention;

FIG. 32 shows an example of RB allocation according to Embodiment 9 of the present invention;

FIG. 33 shows another example of RB allocation according to Embodiment 9 of the present invention;

FIG. 34 shows a further example of RB allocation according to Embodiment 9 of the present invention;

FIG. 35 shows a still further example of RB allocation according to Embodiment 9 of the present invention;

FIG. 36 shows an example of received quality information according to Embodiment 10 of the present invention;

FIG. 37 shows an example of RB allocation according to Embodiment 10 of the present invention;

FIG. 38 shows an example of VRB according to the present invention;

FIG. 39 shows an example of sequential order information allocation according to the present invention; and

FIG. 40 shows an example of transmission start timing according to the present invention.

### BEST MODE FOR CARRYING OUT THE INVENTION

Embodiments of the present invention will be explained below in detail with reference to the accompanying drawings.

### Embodiment 1

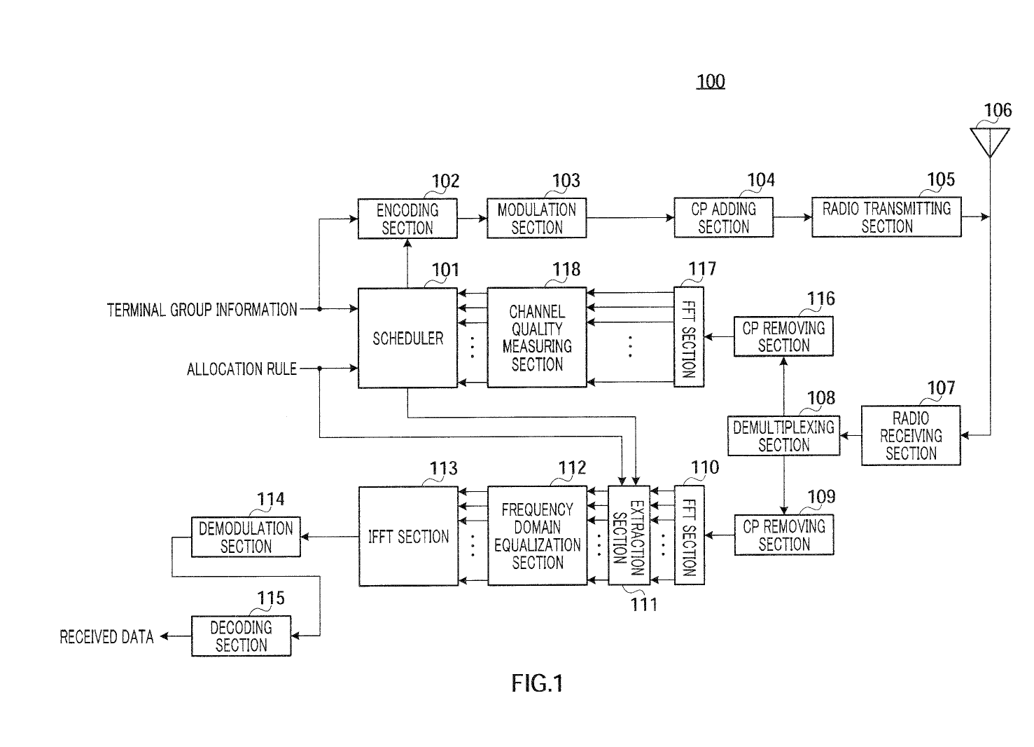

FIG. 1 shows a configuration of base station 100 according to the present embodiment.

A plurality of terminals which become other parties of communication for base station 100 are classified into terminals to which RB's are allocated by FSA according to channel quality and terminals to which RB's are allocated according to predetermined allocation rules. Hereinafter, suppose the group of terminals to which RB's are allocated by FSA according to channel quality and to which a scheduling result represented by RB numbers is reported every time FSA is performed is the first group, and the group of terminals to which RB's are allocated according to predetermined allocation rules is the second group. Here, the allocation rule is shared between the base station and terminals, so that each terminal belonging to the second group is able to identify the RB's allocated to the terminal over a plurality of subframes out of remaining RB's excluding the RB's allocated to terminals belonging to the first group, from all the RB's that are available for allocation.

In base station 100, terminal group information showing which terminal belongs to which group is inputted to scheduler 101 and encoding section 102.

The terminal group information is encoded in encoding section 102, modulated in modulation section 103, added a CP in CP (Cyclic Prefix) adding section 104, subjected to transmission processing such as D/A conversion, amplification and up-conversion in radio transmitting section 105 and transmitted as a control signal to each terminal from antenna 106. Transmission of this terminal group information is performed at such times as initial signaling to each terminal and a change of terminal group information.

Scheduler 101 performs scheduling for every subframe whereby a plurality of RB's on the frequency domain are allocated to terminals belonging to the first group and terminals belonging to the second group. In this case, scheduler 101 allocates RB's to terminals belonging to the first group based on FSA according to the channel quality for each terminal and each RB, and then performs scheduling to allocate remaining RB's other than the RB's allocated to terminals belonging to the first group, to the second group according to a predetermined allocation rules. That is, scheduler 101 performs RB allocation to terminals belonging to the first group preferentially over RB allocation to terminals belonging to the second group. Scheduler 101 then outputs the result of scheduling for terminals belonging to the first group, that is, FSA result, to encoding section 102 and extraction section 111 every time scheduler 101 performs FSA (that is, on a per subframe basis), whereas scheduler 101 does not output the result of scheduling for terminals belonging to the second group. More specifically, the scheduling result here is an expression of RB's allocated to the individual terminals by RB numbers Details of scheduling performed in scheduler 101 will be described later.

Furthermore, when a terminal that newly starts communication with base station 100 is a terminal belonging to the second group or when communicating terminal switches from the first group to the second group, scheduler 101 outputs information showing the RB of which number among the remaining RB's is allocated to the terminal, that is, information identifying the sequential order of the terminal among the remaining RB's (sequential order information), to encoding section 102 and extraction section 111, as initial information for the terminal. This sequential order information is encoded in encoding section 102, modulated in modulation section 103, added a CP in CP adding section 104, subjected to transmission processing such as D/A conversion, amplification and up-conversion in radio transmitting section 105 and transmitted from antenna 106 as a control signal at the time of initial signaling to terminals belonging to the second group.

The FSA result is encoded in encoding section 102, modulated in modulation section 103, added a CP in CP adding section 104, subjected to transmission processing such as D/A conversion, amplification and up-conversion in radio transmitting section 105 and transmitted as a control signal from antenna 106, to both terminals belonging to the first group and terminals belonging to the second group. On the other hand, since scheduler 101 does not output the scheduling result for a terminal belonging to the second group, radio transmitting section 105 does not transmit the scheduling result for the terminals belonging to the second group.

Radio receiving section 107 performs receiving processing such as down-conversion and A/D conversion to a signal from each terminal received via antenna 106 and outputs the signal to demultiplexing section 108. The received signal from each terminal includes data symbols and pilot symbols, which are reference signals.

Demultiplexing section 108 separates the received signal into data symbols and pilot symbols, outputs the data symbols to CP removing section 109 and the pilot symbols to CP removing section 116.

CP removing section 109 removes the CP added to each data symbol, and outputs the data symbol after the removal of the CP, to FFT (Fast Fourier Transform) section 110.

FFT section 110 performs an FFT with the data symbol. This FFT converts the data symbol from a time domain to a frequency domain and obtains a plurality of data symbols mapped to a plurality of subcarriers respectively.

Extraction section 111 extracts data symbols of each terminal mapped to subcarriers of each RB based on the sequential order information, FSA result and allocation rule and outputs the extracted data symbols to frequency domain equalization section 112.

Frequency domain equalization section 112 performs equalization processing in the frequency domain to data symbols sequentially inputted from extraction section 111 for each terminal, to compensate the channel distortion of the data symbols and outputs the data symbols to IFFT (Inverse Fast Fourier Transform) section 113.

IFFT section 113 performs an IFFT with the data symbols after channel distortion compensation on a per terminal basis, to convert the data symbols from the frequency domain to the time domain and outputs the data symbols to demodulation section 114.

Demodulation section 114 demodulates the data symbols and decoding section 115 decodes the demodulated data symbols and outputs the decoded data symbols. In this way, received data from each terminal is obtained.

On the other hand, CP removing section 116 removes the CP added to each pilot symbol, and outputs the pilot symbol after the removal of the CP, to FFT section 117.

FFT section 117 performs an FFT with the pilot symbol. This FFT converts the pilot symbol from the time domain to the frequency domain and obtains a plurality of pilot symbols mapped to a plurality of subcarriers respectively.

Channel quality measuring section 118 measures received quality of the plurality of pilot symbols in the frequency domain as channel quality for each uplink subcarrier and outputs the measurement result to scheduler 101. As will be described later, since each terminal maps pilot symbols over a plurality of RB's, channel quality measuring section 118 can obtain channel quality for each terminal and each RB through this measurement. Channel quality measuring section 118 can measure received quality according to received SNR, received SIR, received SINR, received CINR, received power, interference power, bit error rate, throughput or MCS capable of achieving a predetermined error rate and so on.

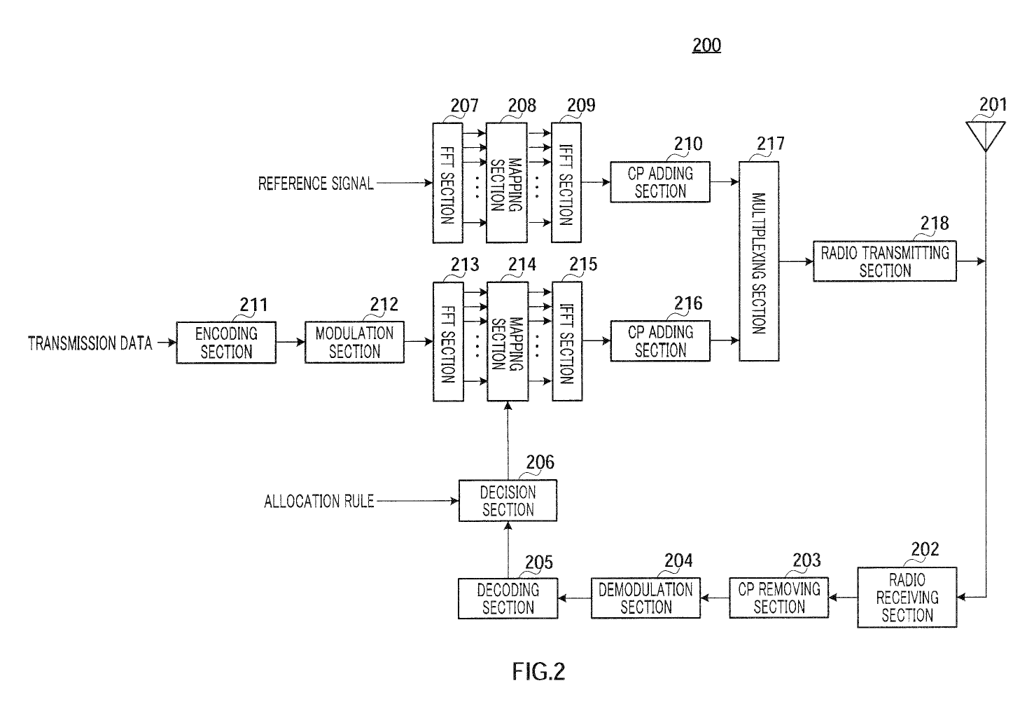

Next, FIG. 2 shows a configuration of terminal 200 according to the present embodiment that can communicate with base station 100.

In terminal 200, radio receiving section 202 performs receiving processing such as down-conversion and A/D conversion to a control signal (terminal group information, sequential order information, FSA result) received from base station 100 via antenna 201 and outputs the control signal to CP removing section 203.

CP removing section 203 removes the CP added to each control signal and outputs the control signal after the removal of the CP, to demodulation section 204.

Demodulation section 204 demodulates the control signal and decoding section 205 decodes the demodulated control signal and outputs the decoded signal to decision section 206.

When terminal group information shows that the terminal belongs to the first group, decision section 206 decides the RB allocated to its own terminal based on the FSA result, and outputs the decision result to mapping section 214.

On the other hand, when the terminal group information shows that the terminal belongs to the second group, decision section 206 decides the RB allocated to its own terminal based on a predetermined allocation rule, sequential order information reported at the time of initial signaling and the FSA result reported per subframe, and outputs the decision result to mapping section 214. When the terminal belongs to the second group, decision section 206 identifies RB's other than the RB's allocated to terminals belonging to the first group as candidates for the RB allocated to its own terminal based on the FSA result. Decision section 206 then decides the RB allocated to its own terminal out of the RB candidates, according to the sequential order information and allocation rule.

FFT section 207 performs an FFT with a plurality of pilot symbols, which are reference signals. This FFT converts the plurality of pilot symbols from the time domain to the frequency domain.

Mapping section 208 maps pilot symbols to subcarriers allocated in advance to its own terminal, one for each RB and outputs the pilot symbols to IFFT section 209.

IFFT section 209 performs an IFFT with the mapped pilot symbols, to convert the pilot symbols from the frequency domain to the time domain and outputs the pilot symbols to CP adding section 210.

CP adding section 210 adds CP's to the pilot symbols on a per block basis, and outputs the pilot symbols to multiplexing section 217.

Encoding section 211 encodes transmission data and outputs the encoded transmission data to modulation section 212.

Modulation section 212 modulates the encoded transmission data to generate data symbols and outputs the data symbols to FFT section 213.

FFT section 213 performs an FFT with the data symbols. FFT section 213 performs an FFT with L×n data symbols (L is the number of subcarriers per RB and n is the number of RB's allocated to its own terminal). This FFT converts L×n data symbols from the time domain to the frequency domain.

Mapping section 214 maps L×n data symbols to n RBIs allocated to its own terminal according to the decision result in decision section 206, and outputs the mapped data symbols to IFFT section 215.

IFFT section 215 performs IFFT to the mapped data symbols to convert the data symbols from the frequency domain to the time domain, and outputs the data symbols to CP adding section 216.

CP adding section 216 adds CP's to the data symbols on a per block basis, and outputs the data symbols to multiplexing section 217.

Multiplexing section 217 time-domain-multiplexes the pilot symbols and data symbols and outputs the multiplexed symbols to radio transmitting section 218.

Radio transmitting section 218 performs transmission processing such as D/A conversion amplification and up-conversion to the pilot symbols and data symbols and transmits these symbols from antenna 201 to base station 100.

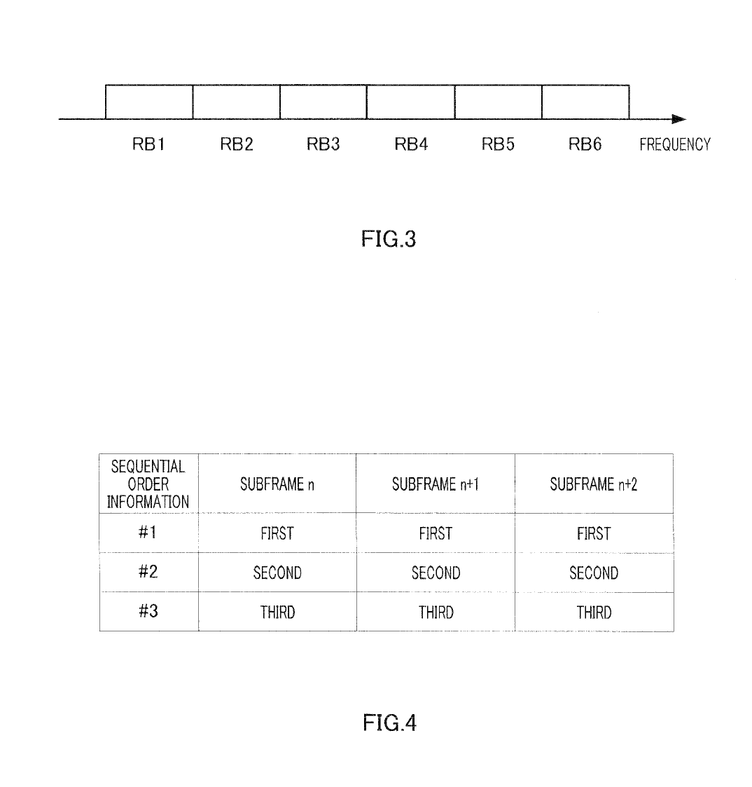

Next, the details of the scheduling carried out in scheduler 101 of base station 100 will be explained. In the following explanations, suppose the frequency band available to this communication system (all subcarriers) is divided into RB's 1 to 6, as shown in FIG. 3. Furthermore, suppose terminals A to C belong to the first group and terminals D to F belong to the second group. Furthermore, suppose FSA is performed on a per subframe basis. Furthermore, as for the priority rank of each terminal in the first group, terminal A has the highest priority, terminal B has the next highest priority and terminal C has the lowest priority. Furthermore, sequential order information #1 to #3 will be used as sequential order information. Furthermore, the allocation rule over a plurality of subframes n to n+2 is shown in the table of FIG. 4. That is, the present embodiment uses an allocation rule that defines sequential order of the remaining RB's of each terminal belonging to the second group over a plurality of subframes. Furthermore, the present embodiment uses an allocation rule that the sequential order of terminals D to F does not change even if the subframes change (that is, even if time passes).

As shown above, scheduler 101 performs RB allocation to terminals A to C belonging to the first group preferentially over RB allocation to terminals D to F belonging to the second group, allocates one of RB's 1 to 6 to terminals A to C based on FSA according to the channel quality for each terminal and for each RB, and then allocates the remaining RB's other than the RB's allocated to terminals A to C, to terminals D to F, according to the allocation rule shown in FIG. 4. More detailed scheduling will be performed as follows.

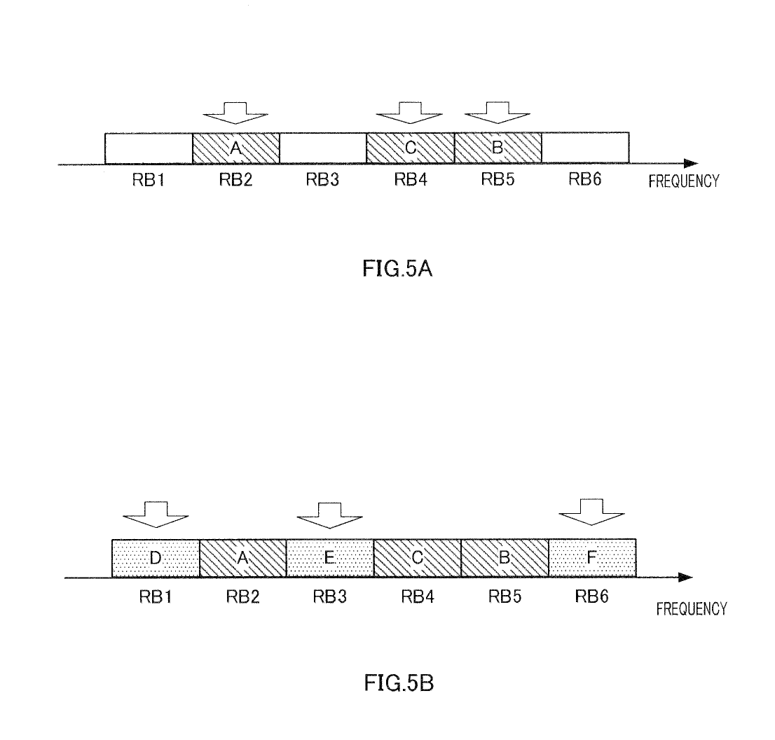

In subframe n, targeting all of RB's 1 to 6, scheduler 101 first performs FSA for terminals A to C belonging to the first group. Here, suppose RB 2 has the highest channel quality of terminal A, RB 5 has the highest channel quality of terminal B and RB 4 has the highest channel quality of terminal C among RB's 1 to 6. Therefore, as a result of this FSA, RB 2 is allocated to terminal A, RB 5 is allocated to terminal B and RB 4 is allocated to terminal C as shown in FIG. 5A. In the case where RB's having the highest channel quality overlap between terminals A to C, RB allocation is performed according to the above-described priority rank.

Next, scheduler 101 allocates the remaining RB's 1, 3 and 6, which do not include RB's 2, 4 and 5 allocated to terminals A to C, to terminals D to F, according to the allocation rule shown in FIG. 4. Here, suppose sequential order information #1 is transmitted to terminal D, sequential order information #2 to terminal E and sequential order information #3 to terminal F, at the times of initial signaling to the individual terminals. Therefore, as shown in FIG. 5B, scheduler 101 allocates first RB 1 of the remaining RB's 1, 3 and 6 to terminal D, second RB 3 to terminal E and third RB 6 to terminal F.

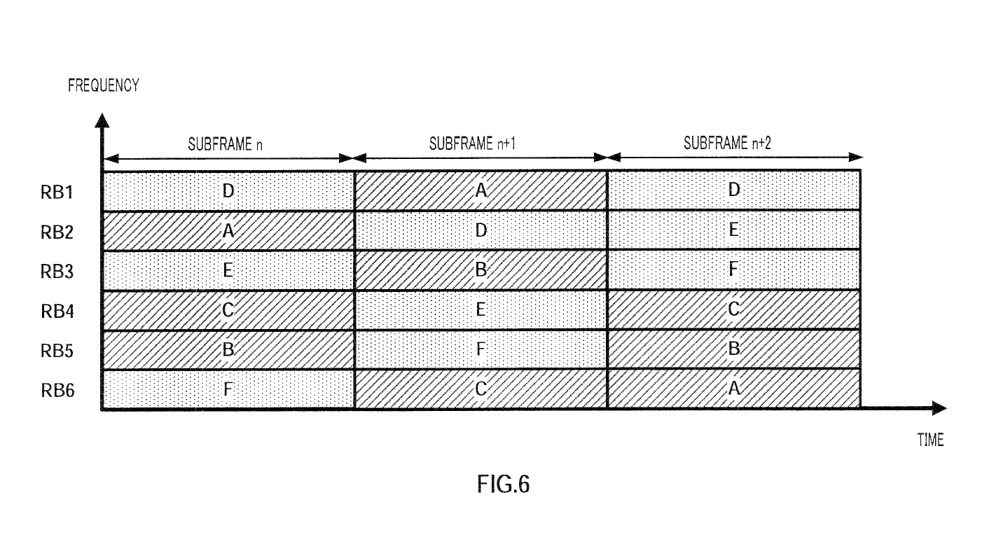

As a result of scheduler 101 performing such scheduling also in subframes n+1 and n+2, the scheduling result in subframes n to n+2 is as shown in FIG. 6, for example. FIG. 6 shows a case where the remaining RB's in subframe n+1 are RB's 2, 4 and 5 and the remaining RB's in subframe n+2 are RB's 1, 2 and 3. Therefore, in subframe n+1, first RB 2 of the remaining RB's 2, 4 and 5 is allocated to terminal D, second RB's 4 to terminal E and third RB 5 to terminal F. Likewise, in subframe n+2, the first RB 1 of the remaining RB's 1, 2 and 3 is allocated to terminal D, second RB 2 to terminal E and third RB 3 to terminal F.

The result of FSA for each subframe, that is, the scheduling result for terminals A to C is transmitted to all terminals A to F, whereas the scheduling result for terminals D to F is not transmitted. However, since any of sequential order information #1 to #3 is reported to terminals D to F at the time of initial signaling, after sequential order information is received, it is possible to decide the RB's allocated to its own terminal from the result of scheduling for terminals A to C based on the allocation rule shown in FIG. 4 even if the result of scheduling for terminals D to F is not reported.

More specifically, when, for example, terminal D is reported that RB 2 is allocated to terminal A, RB 4 is allocated to terminal C and RB 5 is allocated to terminal B in subframe n, decision section 206 decides the RB allocated to its own terminal according to the allocation rule shown in FIG. 4 from among remaining RB's 1, 3 and 6 as candidates. Therefore, decision section 206 of terminal D can decide that the RB allocated to its own terminal in subframe n is RB 1, which is the first RB in remaining RB's 1, 3 and 6 even if the result of scheduling for terminals D to F is not reported. Likewise, even if the result of scheduling for terminals D to F is not reported, decision section 206 of terminal E can decide that the RB allocated to its own terminal in subframe n is RB 3, which is the second RB in remaining RB's 1, 3 and 6 and decision section 206 of terminal F can decide that the RB allocated to its own terminal is RB 6, which is the third RB in remaining RB's 1, 3 and 6. The same applies to other subframes n+1 and n+2.

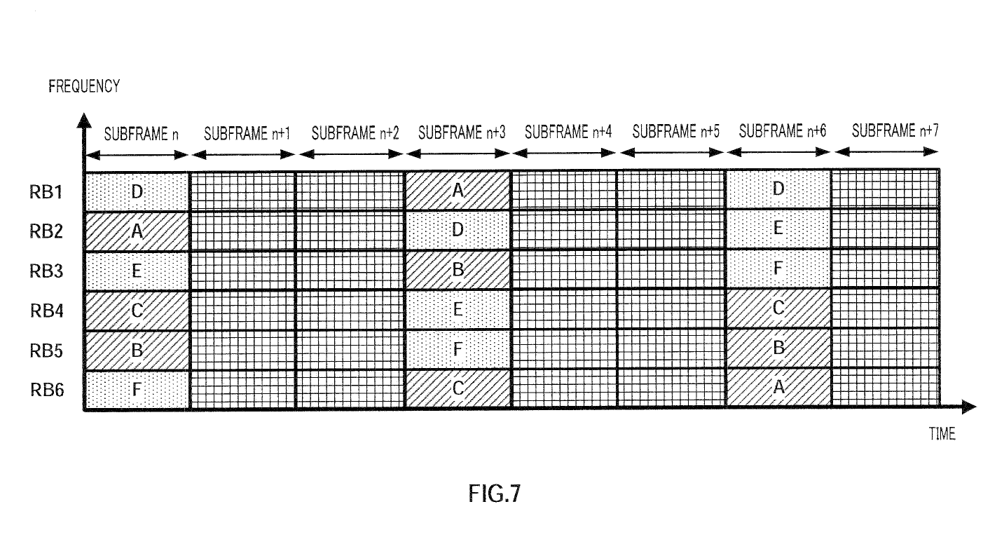

FIG. 6 shows the case where scheduler 101 performs scheduling for every subframe as an example, but, as shown in FIG. 7, scheduler 101 may also perform scheduling once every several subframes. FIG. 7 shows a case where scheduler 101 performs scheduling once every 3 subframes.

In this way, in accordance with the present embodiment, FSA for terminals A to C is performed targeting all of RB's 1 to 6, so that the multiuser diversity effect at terminals A to C can be improved compared to the prior art. Furthermore, in accordance with the present embodiment, sequential order information is reported instead of reporting allocation patterns to terminals D to F, which is the conventionally practice, and also the base station and terminals share the allocation rule, so that it is not necessary to report scheduling results to terminals D to F. That is, the present embodiment can provide substantial multiuser diversity effect while suppressing increases of overhead of report signals.

### Embodiment 2

The present embodiment is the same as Embodiment 1 in using an allocation rule which defines sequential order of the remaining RB's in each terminal belonging to the second group over a plurality of subframes but is different from Embodiment 1 in using an allocation rule whereby sequential order of terminals D to F changes as the subframes change (that is, as time passes).

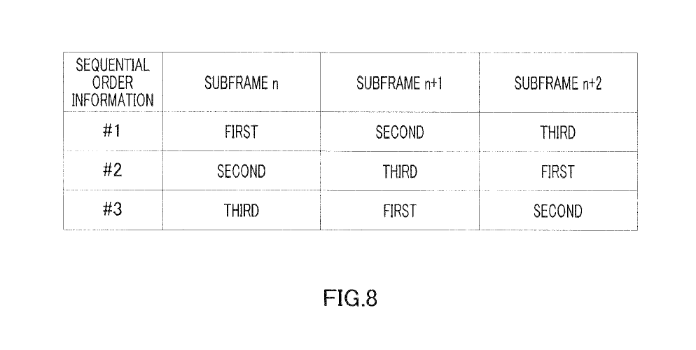

More specifically, the present embodiment uses the allocation rule shown in the table of FIG. 8 instead of the allocation rule shown in the table of FIG. 4. Here, suppose sequential order information #1 to #3 are used as sequential order information and sequential order information #1 is transmitted to terminal D, sequential order information #2 to terminal E and sequential order information #3 to terminal F respectively at the times of initial signaling to the individual terminals.

As in the case of Embodiment 1, scheduler 101 performs FSA for terminals A to C and then allocates the remaining RB's 1, 3 and 6, other than RB's 2, 4 and 5 allocated to terminals A to C, to terminals D to F, according to the allocation rule shown in FIG. 8.

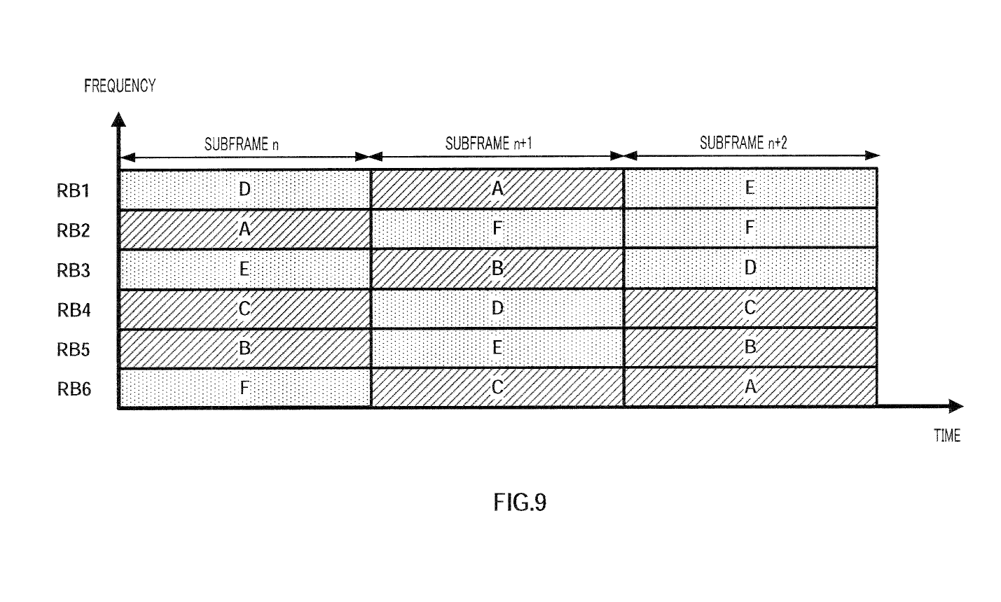

Therefore, the scheduling result in subframes n to n+2 is as shown in FIG. 9, for example. As in the case of Embodiment 1, FIG. 9 shows a case where remaining RB's in subframe n are RB's 1, 3 and 6, remaining RB's in subframe n+1 are RB's 2, 4 and 5 and the remaining RB's in subframe n+2 are RB's 1, 2 and 3. Therefore, according to the allocation rule shown in the table of FIG. 8, first RB 1 of the remaining RB's 1, 3 and 6 is allocated to terminal D in subframe n, second RB 3 is allocated to terminal E and third RB 6 is allocated to terminal F. Furthermore, in subframe n+1, the first RB 2 in the remaining RB's 2, 4 and 5 is allocated to terminal F, second RB 4 is allocated to terminal D and third RB 5 is allocated to terminal E. Furthermore, in subframe n+2, the first RB 1 in the remaining RB's 1, 2 and 3 is allocated to terminal E, second RB 2 is allocated to terminal F and third RB 3 is allocated to terminal D.

A comparison between the scheduling result shown in FIG. 9 and the scheduling result shown in FIG. 6 shows that the RB allocation to terminals D to F belonging to the second group is performed over a wider frequency band. For example, RB allocation to terminal D is performed over a frequency band of two RB's of RB 1 to RB 3 in FIG. 6, whereas RB allocation is performed over a frequency band of four RB's of RB 1 to RB 4 in FIG. 9.

Therefore, according to the present embodiment, the frequency diversity effect of each terminal belonging to the second group can be improved compared to Embodiment 1.

### Embodiment 3

The present embodiment is different from Embodiment 1 in performing scheduling whereby a plurality of RB's are divided into a plurality of resource block groups (RBG), scheduler 101 allocates RB's to terminals belonging to the first group based on FSA according to the channel quality for each terminal and each RB using each of the plurality of RBG's as a unit, and then allocates remaining RB's other than the RB's allocated to terminals belonging to the first group, to terminals belonging to the second group using each of the plurality of RBG's as a unit, according to predetermined allocation rules. That is, the present embodiment is different from Embodiment 1 in that scheduler 101 performs RB allocation to terminals belonging to the first group for each of the plurality of RBG's preferentially over RB allocation to terminals belonging to the second group.

When a terminal that newly starts communication with base station 100 is a terminal belonging to the second group or when a terminal in communication is changed from the first group to the second group, scheduler 101 according to the present embodiment outputs information for identifying which RBG of the plurality of RBG's is associated with the terminal (association information) as initial information for the terminal to encoding section 102 and extraction section 111. This association information is encoded in encoding section 102, modulated in modulation section 103, added a CP in CP adding section 104, subjected to transmission processing such as D/A conversion, amplification and up-conversion in radio transmitting section 105 and transmitted as a control signal from antenna 106 at the time of initial signaling to terminals belonging to the second group.

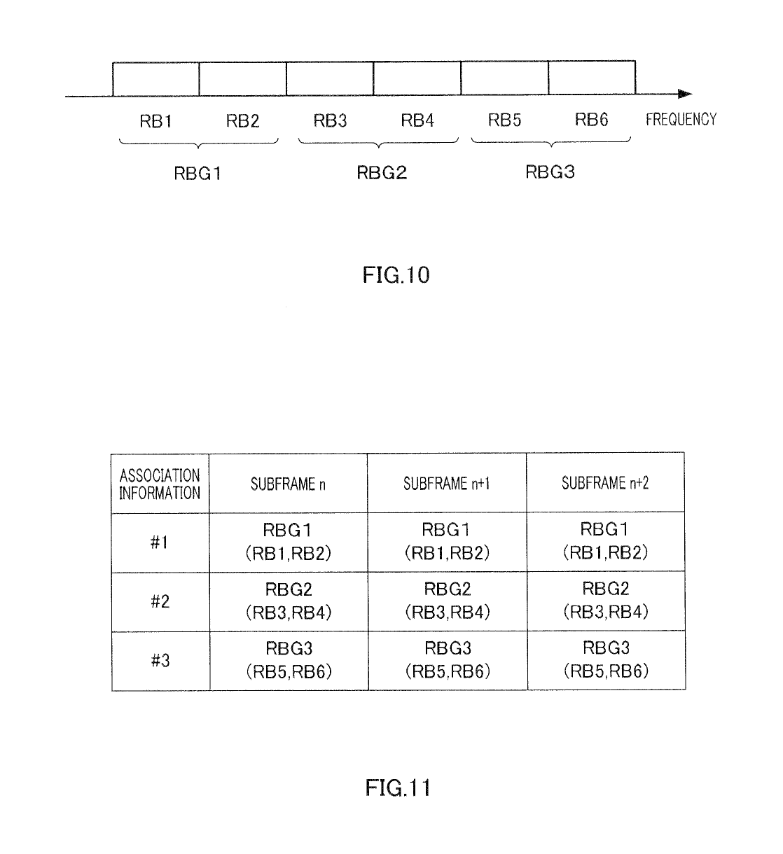

Scheduler 101 according to the present embodiment performs scheduling as shown below. Here, a case as shown in FIG. 10 where RB's 1 to 6 are divided into three RBG's 1 to 3 will be explained. Furthermore, suppose terminals A to C belong to the first group and terminals D to F belong to the second group. Furthermore, FSA is performed per subframe. Furthermore, as for the priority rank of the individual terminals in the first group, suppose terminal A has the highest priority, terminal B has the next highest priority and terminal C has the lowest priority. Furthermore, association information #1 to #3 are used as association information. Furthermore, a table of FIG. 11 shows the allocation rule over a plurality of subframes n to n+2. That is, the allocation rule according to the present embodiment defines the association of each of the plurality of RBG's with terminals belonging to the second group over a plurality of subframes and this allocation rule associates RBG 1 (RB's 1 and 2) with terminal D, RBG 2 (RB's 3 and 4) with terminal E and RBG 3 (RB's 5 and 6) with terminal F respectively, over a plurality of subframes n to n+2. Furthermore, the present embodiment uses the allocation rule as shown in FIG. 11 that even if the subframes change (that is, as time passes), the above-described associations do not change.

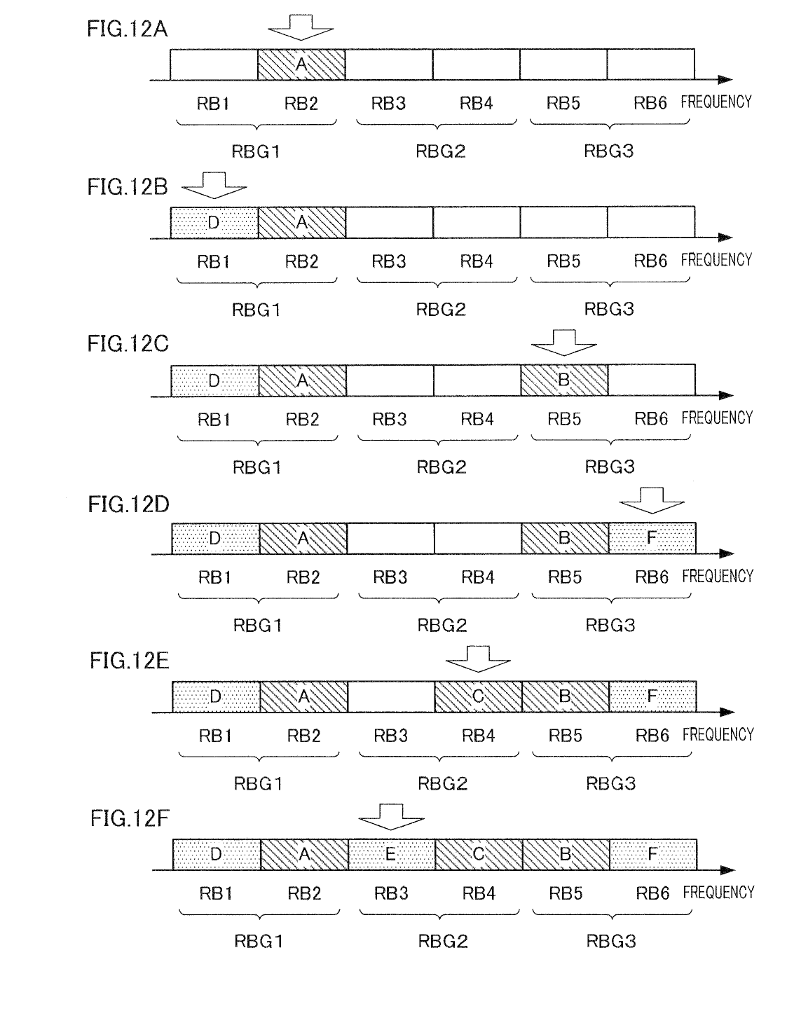

In subframe n, scheduler 101 first performs FSA for terminal A targeting all RBG's 1 to 3 (that is, all of RB's 1 to 6). Here, as for channel quality of terminal A, suppose RB 2 from RB's 1 to 6 has the highest channel quality. Therefore, as a result of this FSA, RB 2 is allocated to terminal A as shown in FIG. 12A.

Since RB 2, which is one of RB 1 and 2 belonging to RBG 1, is allocated to terminal A, as shown in FIG. 12B, scheduler 101 allocates the other one, RB 1, to terminal D based on the above-described associations in the allocation rule shown in FIG. 11. Here, suppose association information #1 is transmitted to terminal D, association information #2 to terminal E and association information #3 to terminal F at the times of initial signaling to the individual terminals.

Next, scheduler 101 performs FSA for terminal B targeting the remaining RBG's 2 and 3 (that is, RB's 3 to 6). Here, as for channel quality of terminal B, suppose RB 5 has the highest channel quality among RB's 3 to 6. Therefore, as a result of this FSA, RB 5 is allocated to terminal B as shown in FIG. 12C.

Since RB 5, which is one of RB 5 and 6 belonging to RBG 3, is allocated to terminal B, as shown in FIG. 12D, scheduler 101 allocates the other one, RB 6, to terminal F based on the above-described associations in the allocation rule shown in FIG. 11.

Next, scheduler 101 performs FSA for terminal C targeting the remaining RBG 2 (that is, RB's 3 and 4). Here, as for channel quality of terminal C, suppose that, between RB's 3 and 4, RB 4 has the higher channel quality. Therefore, as a result of this FSA, RB 4 is allocated to terminal C, as shown in FIG. 12E.

Since one of RB's 3 and 4 belonging to RBG 2, that is, RB 4 in this case, is allocated to terminal C, as shown in FIG. 12F, scheduler 101 allocates the other one, RB 3, to terminal E, based on the above-described associations in the allocation rule shown in FIG. 11.

Thus, RBG's 1 to 3 are each made up of two RB's, and, regarding the allocation rule, one terminal belonging to the second group is associated with one RBG, and scheduler 101 allocates one RB in each of RBG's 1 to 3 to a terminal belonging to the first group and then allocates the other RB to a terminal belonging to the second group, based on the above-described associations.

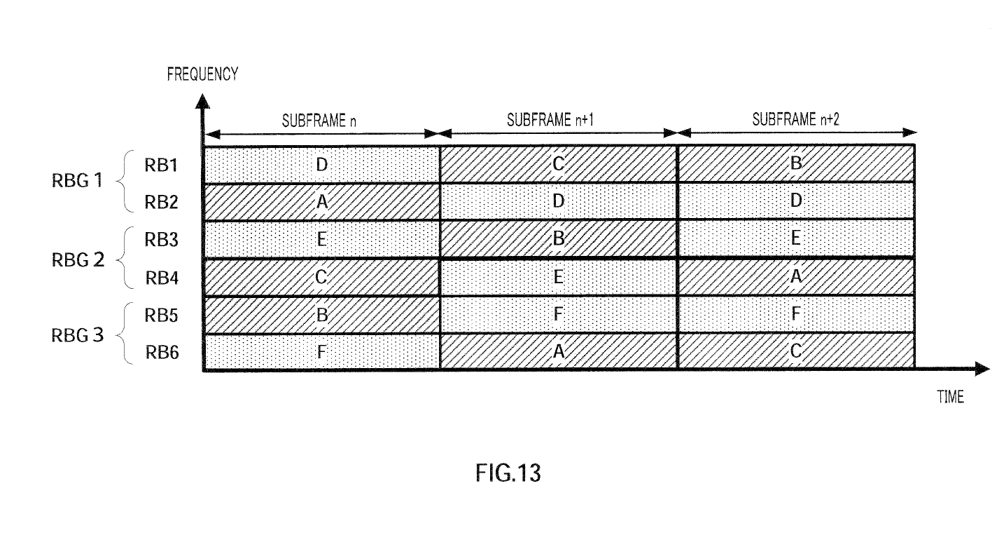

As a result of scheduler 101 performing such scheduling also in subframes n+1 and n+2, the scheduling result in subframes n to n+2 is as shown in FIG. 13, for example. FIG. 13 shows a case where the RB allocation in subframe n is performed in order of RBG's 1, 3 and 2, based on the channel quality of terminals A to C, whereas the RB allocation in subframe n+1 is performed in order of RBG's 3, 2 and 1 and the RB allocation in subframe n+2 is performed in order of RBG's 2, 1 and 3.

The result of FSA for each subframe, that is, the result of scheduling for terminals A to C is transmitted to all terminals A to F, whereas the result of scheduling for terminals D to F is not transmitted. However, since one of association information #1 to #3 is reported to terminals D to F at the time of initial signaling, after receiving the association information, terminals D to F can decide RB's allocated to its own terminals from the result of scheduling for terminals A to C based on the allocation rule shown in FIG. 11 even if the result of scheduling for terminal D to F is not reported.

More specifically, as for terminal D, for example, upon receiving the report that RB 2 is allocated to terminal A in subframe n, decision section 206 can decide that remaining RB 1 in RBG 1 is the RB allocated to its own terminal since RB 2 belongs to RBG 1 and its own terminal is associated with RBG 1 in subframe n according to the allocation rule shown in FIG. 11. Likewise, decision section 206 of terminal E can decide that RB 3 is the RB allocated to its own terminal in subframe n even if the result of scheduling for terminals D to F is not reported and decision section 206 of terminal F can decide that RB 6 is the RB allocated to its own terminal. The same applies to other subframes n+1 and n+2.

As shown above, in accordance with the present embodiment, decision section 206 of terminals D to F belonging to the second group need not refer to the FSA result of all of RB's 1 to 6 as in the case of Embodiment 1, can decide the RB allocated to its own terminal from only the FSA result in the RBG associated with its own terminal, and can thereby decide the RB allocated to its own terminal in a shorter time than Embodiment 1. Moreover, decision section 206 of terminals D to F need not store the FSA result of all of RB's 1 to 6 as in the case of Embodiment 1, needs only to store the FSA result in the RBG associated with its own terminal, and can thereby reduce the circuit scale compared with Embodiment 1.

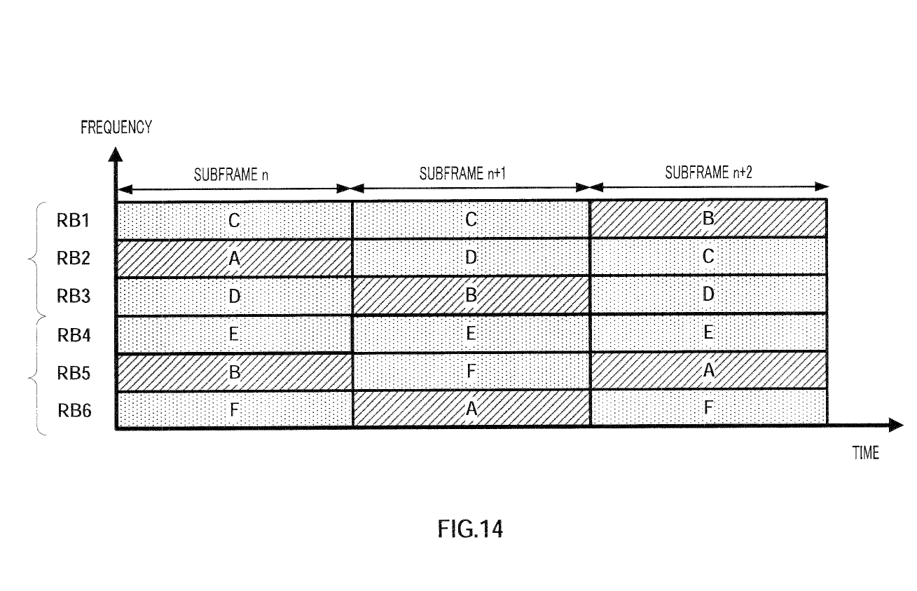

In the above explanation, the case where RB's 1 to 6 are divided into three RBG's has been shown as an example, but the number of REG's (i.e. the number of divisions) is not limited to 3. For example, as shown in FIG. 14, when RB's 1 to 6 are divided into two RBG's 1 and 2, terminals A and B belong to the first group and terminals C to F belong to the second group, RB allocation may be performed to terminals C to F in each RBG according to the sequential order explained in Embodiment 1. That is, in FIG. 14, suppose RBG 1 (RB's 1 to 3) is associated with terminals C and D and RBG 2 (RB's 4 to 6) is associated with terminals E and F and the sequential order in RBG 1 is the order of terminals C and D (first: terminal C, second: terminal D), and the sequential order in RBG 2 is the order of terminals E and F (first: terminal E, second: terminal F).

Therefore, in subframe n, for example, scheduler 101 first performs FSA for terminal A targeting all RBG's 1 and 2 (that is, all of RB's 1 to 6). Here, as for channel quality of terminal A, suppose RB 2 has the highest channel quality among RB's 1 to 6. Therefore, as a result of this FSA, as shown in FIG. 14 (subframe n), RB 2 is allocated to terminal A. Since RB 2 from RB's 1 to 3 belonging to RBG 1 is allocated to terminal A, scheduler 101 allocates RB 1 of remaining RB 1 and 3 to terminal C and allocates RB 3 to terminal D according to the above-described sequential order in RBG 1 as shown in FIG. 14 (subframe n).

Next, scheduler 101 performs FSA for terminal B targeting the remaining RBG 2 (that is, RB's 4 to 6). Here, as for channel quality of terminal B, suppose RB 5 has the highest channel quality among RB's 4 to 6. Therefore, as a result of this FSA, as shown in FIG. 14 (subframe n), RB 5 is allocated to terminal B. Since RB 5 of RB's 4 to 6 belonging to RBG 2 is allocated to terminal B, scheduler 101 allocates RB 4 from the remaining RB's 4 and 6 to terminal E and allocates RB 6 to terminal F according to the above-described sequential order in RBG 2 as shown in FIG. 14 (subframe n).

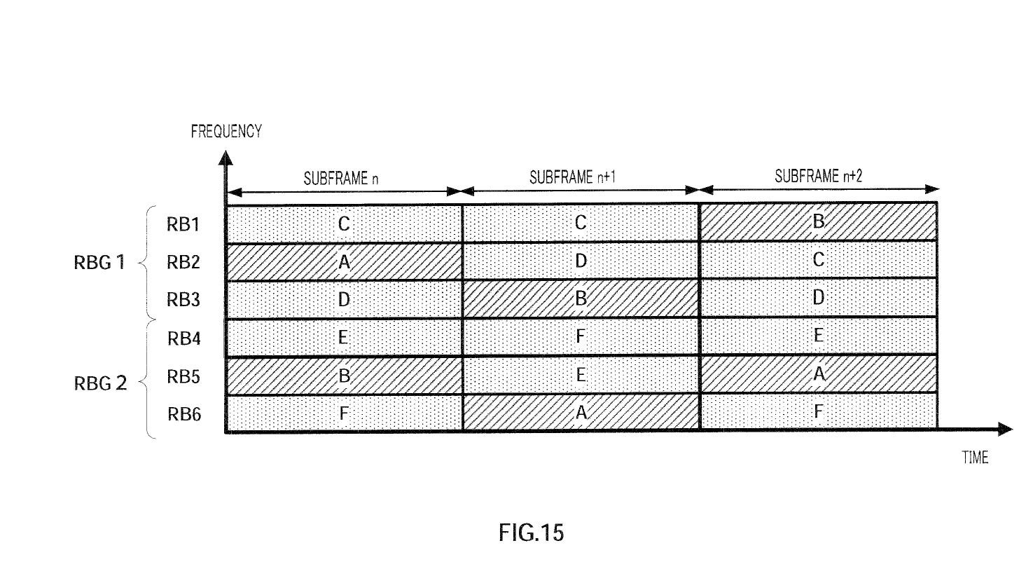

Furthermore, when RB's 1 to 6 are divided into two RBG's 1 and 2, the sequential order of each terminal belonging to the second group may be changed in each RBG as the subframes change (that is, as time passes), as in the case of Embodiment 2. FIG. 15 shows a case where under the same condition as that in FIG. 14, the sequential order in RBG 1 is changed to the order of terminals C and D in subframe n, the order of terminals D and C in subframe n+1 and the order of terminals C and D in subframe n+2, while the sequential order in RBG 2 is changed to the order of terminals E and F in subframe n, the order of terminals F and E in subframe n+1 and the order of terminals E and F in subframe n+2. As in the case of Embodiment 2, this makes it possible to further improve the frequency diversity effect of each terminal belonging to the second group in each RBG.

Furthermore, all the RB's in some of a plurality of RBG's may be allocated only to terminals belonging to the first group or only to terminals belonging to the second group. Furthermore, part of all RB's may be grouped as RBG's and the present invention may be applied to only RB's included in these RBG's.

### Embodiment 4

The present embodiment is the same as Embodiment 1 in that a plurality of RB's are divided into a plurality of RBG's and an allocation rule is used which defines the associations of a plurality of RBG's with terminals belonging to the second group over a plurality of subframes, yet is different from Embodiment 3 in that an allocation rule is used whereby the associations or the RB's making up the RBG's change as the subframes change (that is, as time passes).

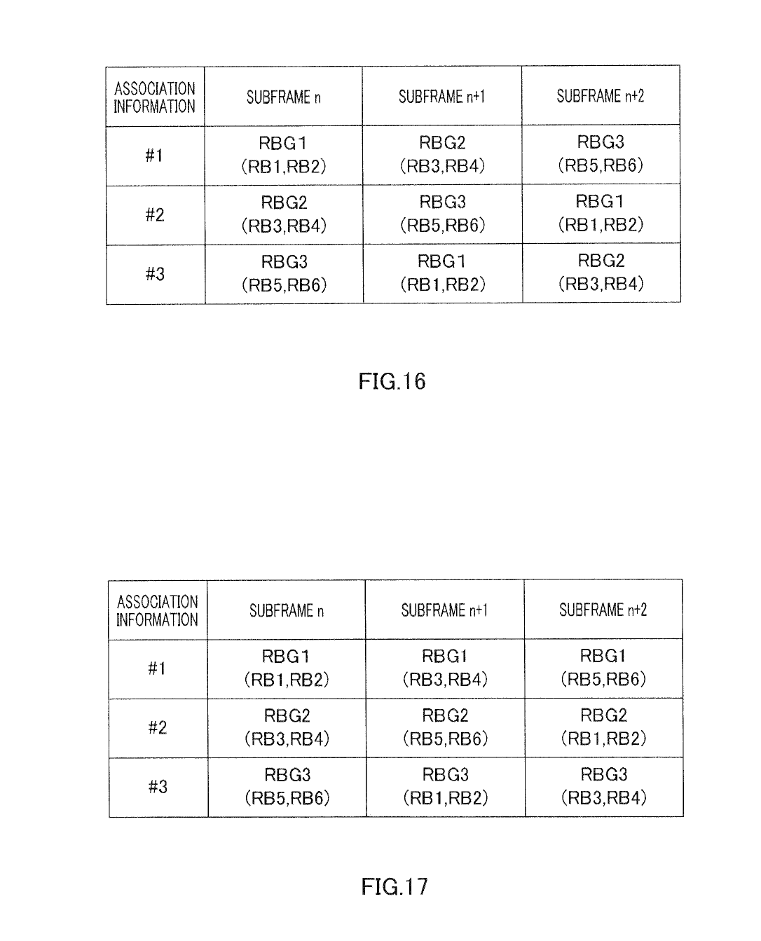

More specifically, the present embodiment uses the allocation rule shown in the table of FIG. 16 or FIG. 17, instead of the allocation rule shown in the table of FIG. 11. Here, suppose association information #1 to #3 are used as association information and association information #1 is transmitted to terminal D, association information #2 to terminal E and association information #3 to terminal F at the times of initial signaling to the individual terminals.

According to the allocation rule shown in the table of FIG. 16, the associations of RBG's 1 to 3 with terminals D to F belonging to the second group, change on a per subframe basis. When, for example, to place the focus on terminal D, terminal D is associated with RBG 1 in subframe n, with RBG 2 in subframe n+1 and with RBG 3 in subframe n+2. The same applies to other terminals E and F. On the other hand, the RB's making up RBG's 1 to 3 remain unchanged as RB's 1 and 2 in RBG 1, RB's 3 and 4 in RBG 2 and RB's 5 and 6 in RBG 3, and unchanged even when the subframes change.

On the other hand, according to the allocation rule shown in the table of FIG. 17, the RB's making up RBG's 1 to 3 change on a per subframe basis. When, for example, to place the focus on RBG 1, RBG 1 is made up of RB 1 and 2 in subframe n, made up of RB's 3 and 4 in subframe n+1 and made up of RB's 5 and 6 in subframe n+2. The same applies to other RBG's 2 and 3. On the other hand, the associations of RBG's 1 to 3 with terminals D to F belonging to the second group remain unchanged as terminal D with RBG 1, terminal E with RBG 2 and terminal F with RBG 3, and unchanged even when the subframes change.

Scheduler 101 performs RB allocation to terminals D to F using the allocation rule shown in the table of FIG. 16 or FIG. 17 as in the case of Embodiment 3.

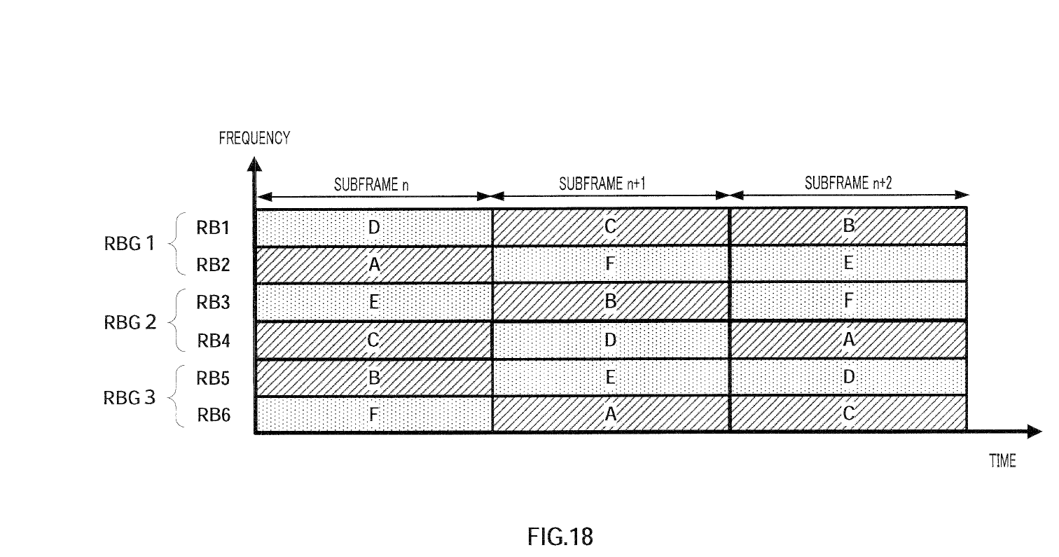

Therefore, the scheduling result in subframes n to n+2 is as shown in FIG. 18, for example. FIG. 18 shows a case where the result of FSA for terminals A to C belonging to the first group is identical to that in FIG. 13 (Embodiment 3). Therefore, when the RB allocation shown in FIGS. 12A to F (Embodiment 3) is performed to terminals D to F belonging to the second group according to the allocation rule shown in the table of FIG. 16 or FIG. 17, RB 1 is allocated to terminal D, RB 3 to terminal E and RB 6 to terminal F in subframe n. Furthermore, in subframe n+1, RB 2 is allocated to terminal F, RB's 4 to terminal D and RB 5 to terminal E. Furthermore, in subframe n+2, RB 2 is allocated to terminal E, RB 3 to terminal F and RB 5 to terminal D.

A comparison between the scheduling result shown in FIG. 18 and the scheduling result shown in FIG. 13 shows that RB allocation to each of terminals D to F belonging to the second group is performed over a wider frequency band. That is, RB allocation to each terminal D to F is performed limited to a frequency band of two RB's in FIG. 13, whereas, in FIG. 18, RB allocation is performed over a whole frequency band of six RB's 1 to 6.

Thus, in accordance with the present embodiment, the frequency diversity effect of each terminal belonging to the second group can be improved compared to Embodiment 3.

### Embodiment 5

When terminals belonging to the second group are added or terminals belonging to the first group are changed to the second group or the like, the number of terminals belonging to the second group increases. On the other hand, when a terminal belonging to the second group terminates communication or is switched to the first group, or when the period of belongs to the second group passes (i.e. the number of subframes over which the terminal belongs to the second group), the number of terminals belonging to the second group decreases.

For example, suppose a case where, in Embodiment 1, terminal E, to which sequential order information #2 (i.e. the second RB) is reported out of terminals D, E and F belonging to the second group, leaves the second group, and the number of terminals belonging to the first group is incremented by one to make up for terminal E. In this case, since the number of the remaining RB's out of RB's 1 to 6 decreases from three to two, terminal F, to which sequential order information #3 (i.e. the third RB) is reported, cannot decide the RB allocated to terminal F.

Therefore, the present embodiment will explain how to support a case where the number of terminals belonging to the second group increases or decreases, using following examples 1 to 4.

### Example 1

In the present example, the timing to update terminals belonging to the second group is fixed the same in advance between all terminals, so that terminals belonging to the second group are not allowed to change at timings other than the fixed timing. That is, the number of terminals belonging to the second group does not change at timings other than that update timing. Scheduler 101 of base station 100 outputs sequential order information only at that update timing.

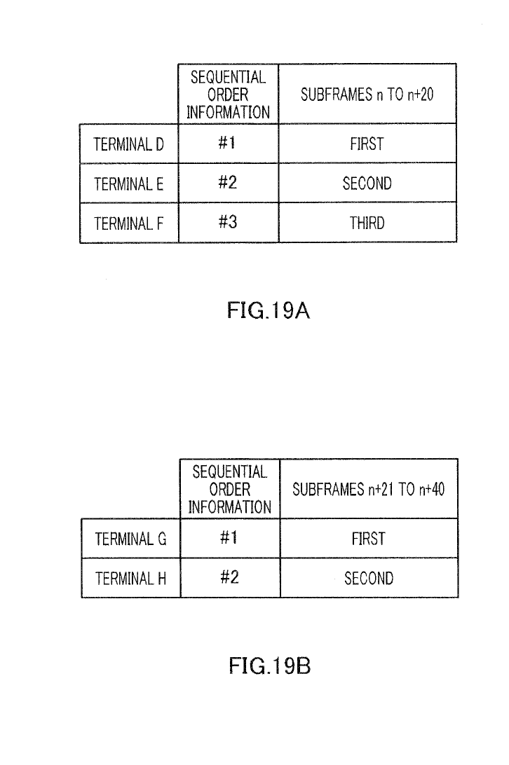

More specifically, for example, as shown in FIGS. 19A and B, the update timing of terminals belonging to the second group is determined in advance as subframe n and subframe n+21 between all terminals. Therefore, the update cycle is twenty subframes.

Therefore, scheduler 101 outputs sequential order information #1 (i.e. the first RB) as the sequential order information for terminal D, sequential order information #2 (i.e. the second RB) as the sequential order information for terminal E and sequential order information #3 (i.e. the third RB) as the sequential order information for terminal F in subframe n. Thus, sequential order information #1 to #3 are transmitted to terminals D to F in subframe n.

The terminals belonging to the second group are not allowed to change during the period of subframes n to n+20. The number of terminals belonging to the first group is not allowed to change either.

In subframe n+21, the terminals belonging to the second group are updated from terminals D, E and F to, for example, terminals G and H. The terminals may also be updated to two of terminals D, E and F. That is, in subframe n+21, the number of terminals belonging to the second group is decreased from three to two. In this case, since the number of terminals belonging to the second group is two, scheduler 101 outputs sequential order information #1 (i.e. the first RB) as the sequential order information for terminal G and outputs sequential order information #2 (i.e. the second RB) as the sequential order information for terminal H. That is, scheduler 101 uses only sequential order information #1 and #2 corresponding to the two most significant RB's and does not use sequential order information from #3 onward. In other words, scheduler 101 uses sequential order information in order from the sequential order information associated with the most significant RB amongst the remaining RB's, that is, uses sequential order information in ascending order of the numbers. Therefore, sequential order information #1 and #2 are transmitted to terminals G and H in subframe n+21.

Thus, according to the present example, the same update timing is set between all terminals belonging to the second group and sequential order information is used in order from the sequential order information associated with the most significant RB, so that, even when the number of terminals belonging to the second group increases or decreases, it is possible to prevent terminals belonging to the second group from being unable to decide the RB's allocated to the terminals.

The update timing of terminals belonging to the second group is set preferably according to the number of subframes for the terminal using the maximum number of subframes used among the terminals belonging to the second group.

### Example 2

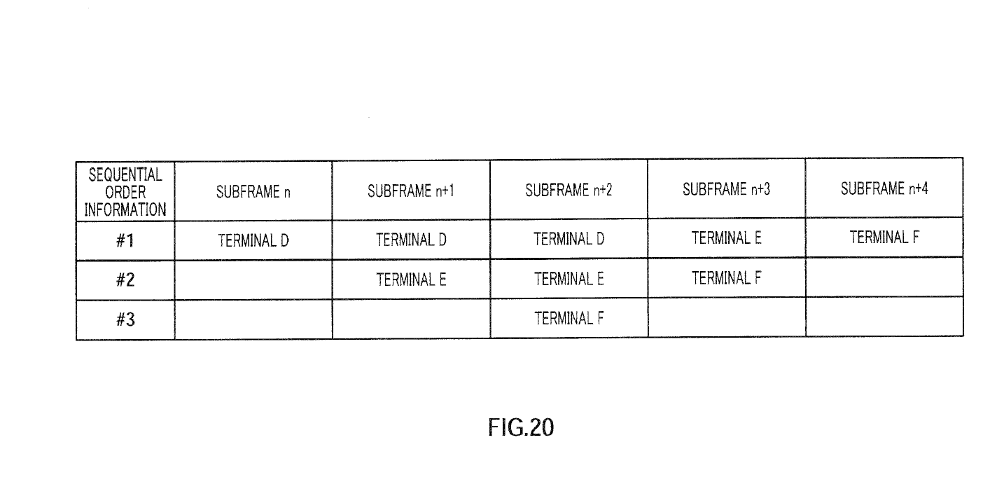

In the present example, the transmission start timing is made different between terminals belonging to the second group. For example, as shown in FIG. 20, suppose the transmission start timing for terminal D is subframe n, the transmission start timing for terminal E is subframe n+1, and the transmission start timing for terminal F is subframe n+2. This allows the timing for transmitting sequential order information to vary between terminals belonging to the second group, and, as a result, it is possible to distribute signaling of sequential order information over subframes and prevent signaling of sequential order information from being concentrated in the same subframes.

Furthermore, in the present example, suppose the cycle of data transmission is the same between all terminals. For example, as shown in FIG. 20, suppose the data transmission interval for terminal D is subframes n to n+2, the data transmission interval for terminal E is subframes n+1 to n+3 and the data transmission interval for terminal F is subframes n+2 to n+4, and in this way, the cycle of data transmission is three subframes for all terminals.

That is, according to the present example, the transmission start timing and transmission end timing vary between terminals belonging to the second group.

In this case, according to the present example, scheduler 101 outputs sequential order information #1 (i.e. the first RB) as sequential order information for terminal D in subframe n, outputs sequential order information #2 (i.e. the second RB) as sequential order information for terminal E in subframe n+1 and outputs sequential order information #3 (i.e. the third RB) as sequential order information for terminal F in subframe n+2. That is, according to the present example, when the number of terminals belonging to the second group increases, sequential order information is used from the sequential order information associated with the most significant RB amongst the sequential information left unused, that is, sequential order information is used in ascending order of the numbers.

As data transmission of terminal D ends in subframe n+2, scheduler 101 updates sequential order information in subframe n+3, allocates the first RB in remaining RB's to terminal E and allocates the second RB to terminal F. However, in this case, scheduler 101 does not transmit new sequential order information #1 and #2 to terminals E and F.

On the other hand, as for terminals E and F, as the number of terminals belonging to the second group decreases, decision section 206 updates sequential order information accordingly. In subframe n+3, since the number of terminals belonging to the second group decreases from three to two and the decrement is one, decision section 206 of terminal E updates the sequential order information from #2 (i.e. the second RB) to #1 (i.e. the first RB) and decision section 206 of terminal F updates the sequential order information from #3 (i.e. the third RB) to #2 (i.e. the second RB). That is, when the number of terminals belonging to the second group decreases, decision section 206 of each terminal belonging to the second group reduces the sequential order information number by the decrement when the sequential order information for terminal is not sequential order information #1 (i.e. the first RB).

Decision section 206 can decide the decrement of terminals belonging to the second group from, for example, the number of RB's specified as candidates (i.e. the number of RB candidates). For example, when the number of RB candidates in subframe n+2 is three and the number of RB candidates in subframe n+3 is two, decision section 206 can decide that the decrement is one.

The case with subframe n+4 is similar to the case of subframe n+3.

In this way, according to the present example, even when the number of terminals belonging to the second group increases or decreases, it is possible to prevent terminals belonging to the second group from being unable to decide the RB's allocated to the terminals. Furthermore, as the number of terminals belonging to the second group decreases, even when base station 100 updates the sequential order information for each terminal, each terminal 200 can update the sequential order information without being reported sequential order information from base station 100 and can therefore prevent the amount of signaling of sequential order information from increasing.

### Example 3

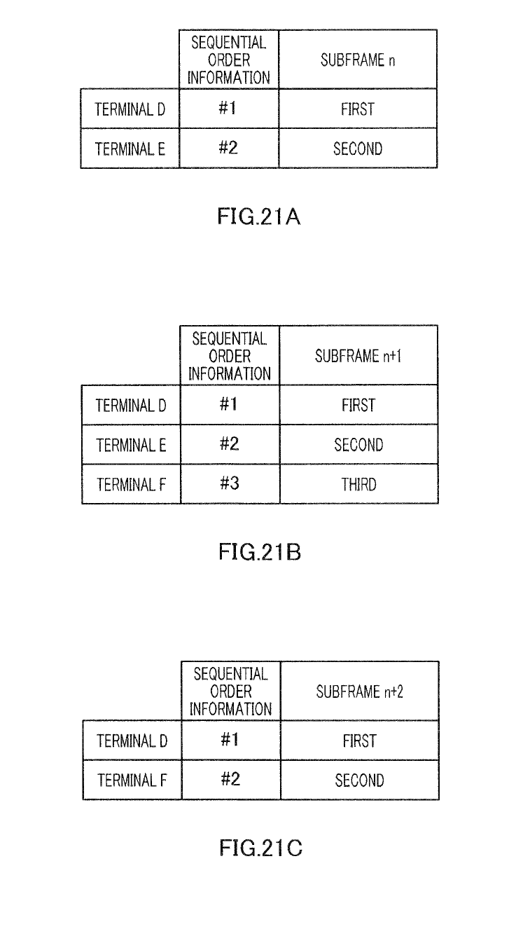

In the present example, as shown in FIG. 21A, suppose sequential order information for terminal D is sequential order information #1 (i.e. the first RB) and sequential order information for terminal E is sequential order information #2 (i.e. the second RB) in subframe n.

When terminal F is added as a terminal to belong to the second group in subframe n+1, scheduler 101 outputs sequential order information #3 (i.e. the third RB) as the sequential order information for terminal F in subframe n+1 as shown in FIG. 21B. Therefore, sequential order information #3 is reported to terminal F in subframe n+1. That is, according to the present example, when the number of terminals belonging to the second group increases, sequential order information is used from the sequential order information associated with the most significant RB amongst the sequential information left unused, that is, sequential order information is used in ascending order of the numbers.

Furthermore, in subframe n+2, when terminal E leaves the second group, scheduler 101 updates the sequential order information for terminal F from #3 (i.e. the third RB) to #2 (i.e. the second RB), as shown in FIG. 21C, and allocates the second RB of the remaining RB's to terminal F. Furthermore, to report the terminals belonging to the second group that terminal E has left the second group, scheduler 101 outputs the sequential order information #2 for terminal E which has left the second group, and this sequential order information #2 is transmitted from base station 100 to terminals belonging to the second group.

In the terminals belonging to the second group, decision section 206 decides the sequential order information for the terminal that left the second group (here #2), and updates the sequential order information according to the sequential order information. That is, decision section 206 of terminal F updates the sequential order information from #3 (i.e. the third RB) to #2 (i.e. the second RB). On the other hand, decision section 206 of terminal D keeps the sequential order information #1 (i.e. the first RB). That is, when the number of terminals belonging to the second group decreases, decision section 206 of each terminal belonging to the second group decides whether the sequential order information number for the terminal having left the second group is smaller than the sequential order information number for the terminal, and, when it is, decrements the sequential order information number by one.

Thus, according to the present example, even when the number of terminals belonging to the second group increases or decreases, it is possible to prevent terminals belonging to the second group from being unable to decide the RB's allocated to the terminals. Furthermore, it is possible to freely set different data transmission intervals for the individual terminals belonging to the second group.

### Example 4

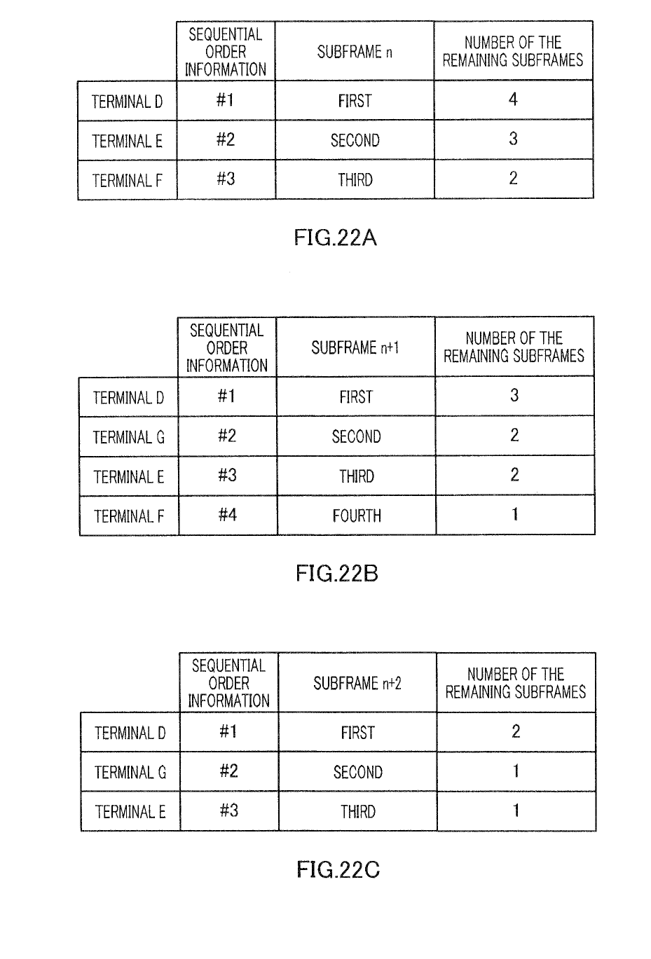

In the present example, in subframe n as shown in FIG. 22A, suppose sequential order information for terminal D is sequential order information 41 (i.e. the first RB), sequential order information for terminal E is sequential order information #2 (i.e. the second RB) and sequential order information for terminal F is sequential order information #3 (i.e. the third RB). Furthermore, in subframe n, suppose the number of remaining consecutive subframes (i.e. the number of the remaining subframes) is four for terminal D, three for terminal E and two for terminal F. That is, the number of the remaining subframes indicates transmission end timing of each terminal. For example, since the number of the remaining subframes for terminal F in subframe n is two, data transmission of terminal F ends in subframe n+1.

In subframe n+1, when terminal G is newly added as a terminal to belong to the second group, scheduler 101 updates the sequential order information for each terminal according to the number of the remaining subframes for terminal G. Here, suppose the number of the remaining subframes for terminal G is two. On the other hand, in subframe n+1, the number of the remaining subframes for terminal D is three, the number of the remaining subframes for terminal E is two and the number of the remaining subframes for terminal F is one. Thus, as shown in FIG. 22B, scheduler 101 arranges terminals D to G in descending order of the numbers of remaining subframes, and determines and updates the sequential order information for the individual terminals according to their order.

Therefore, in subframe n+1, as shown in FIG. 22B, scheduler 101 keeps #1 (i.e. the first RB) as the sequential order information for terminal D, determines the sequential order information for terminal G #2 (i.e. the second RB), updates the sequential order information for terminal E from #2 (i.e. the second RB) to #3 (i.e. the third RB) and updates the sequential order information for terminal F from #3 (i.e. the third RB) to #4 (i.e. the fourth RB). Furthermore, scheduler 101 outputs sequential order information #2 as the sequential order information for terminal G and outputs a control signal reporting to terminals belonging to the second group that #2 has been determined to be the sequential order information for terminal G. Since the number of the remaining subframes for terminal G is the same as the number of the remaining subframes for terminal E, scheduler 101 may determine the sequential order information for terminal G #3, while keeping #1 as the sequential order information for terminal D and #2 as the sequential order information for terminal E, and may update the sequential order information for terminal F from #3 to #4. In this way, in the present example, the sequential order information for each terminal is determined so that terminals having the same number of the remaining subframes appear consecutively in the second group.

On the other hand, in terminal E, decision section 206 decides that #2 has been determined to be the sequential order information for terminal G from a control signal, and updates the sequential order information from #2 to #3. Likewise, in terminal F, decision section 206 decides that #2 has been determined to be the sequential order information for terminal G from a control signal, and updates the sequential order information from #3 to #4.

In the case where the number of terminals belonging to the second group increases, as shown in FIG. 22B, when the sequential order information for each terminal is decided and updated, the smaller the number of the remaining subframes for a terminal, the greater the sequential order information number. Therefore, as shown in FIG. 22C, in subframe n+2, terminal F, which has the maximum sequential order information number, leaves the second group. Therefore, in subframe n+2, the sequential order information for terminals D, G and E need not be updated.

In this way, according to the present example, since terminals that leave the second group can be determined in descending order of the sequential order information numbers, even when the number of terminals belonging to the second group increases or decreases, it is possible to prevent a terminal belonging to the second group from being unable to decide the RB allocated to the terminal and eliminate the necessity for updating sequential order information when the number of terminals belonging to the second group decreases.

### Embodiment 6

The present embodiment sets the priority of each terminal belonging to the second group and assigns sequential order information of a smaller number to a terminal with higher priority.

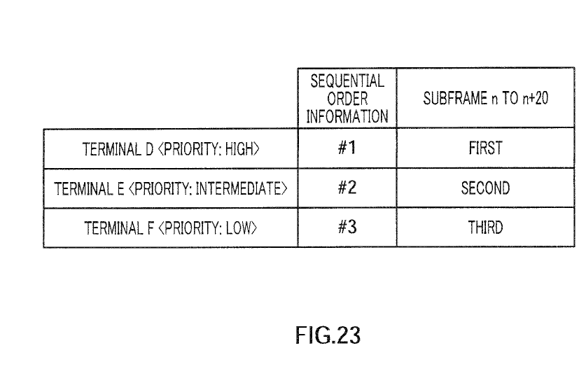

More specifically, for example, as shown in FIG. 23, as for terminals D, E and F belonging to the second group, the priority of terminal D is set to “high,” the priority of terminal E to “intermediate” and the priority of terminal F to “low.” As for the priority of each terminal, the “high” priority is set for a terminal with a high degree of delay requirement allowing no delay, applied to, for example, terminals carrying out VoIP, streaming and gaming, while the “low” priority is set for a terminal with a low degree of delay requirement allowing delay, applied to, for example, terminals carrying out FTP and Web browsing.

Scheduler 101 assigns sequential order information of a smaller number to a terminal having higher priority. More specifically, as shown in FIG. 23, scheduler 101 assigns sequential order information #1 (first) to terminal D, sequential order information #2 (second) to terminal E and sequential order information #3 (third) to terminal F.

Here, a terminal belonging to the second group compares the number of RB's allocated to terminals belonging to the second group with the sequential order information number for the terminal, and performs no transmission when the sequential order in formation number for the terminal is greater than the number of RB's allocated to terminals belonging to the second group, assuming that there is no RB allocated to the terminal. More specifically, when the number of RB's allocated to the second group in subframe n is two, one RB is allocated to terminal D of sequential order information #1 and to terminal E of sequential order information #2 each, but no RB is allocated to terminal F of sequential order information #3. Therefore, the lower the priority of a terminal to be allocated sequential order information of a higher number, the lower the possibility of being allocated an RB.

By allocating sequential order information of a smaller number to a terminal having higher priority, it is possible to allocate remaining RB's to each terminal in order of priority ranks. Therefore, the present embodiment ensures that RB's are allocated to terminals having higher priority even when the number of terminals belonging to the first group increases and the number of the remaining RB's that can be allocated to terminals belonging to the second group decreases.

### Embodiment 7

As opposed to the above-described embodiments that have explained cases where the present invention is applied to uplink RB allocation, the present embodiment will explain a case where the present invention is applied to downlink RB allocation.

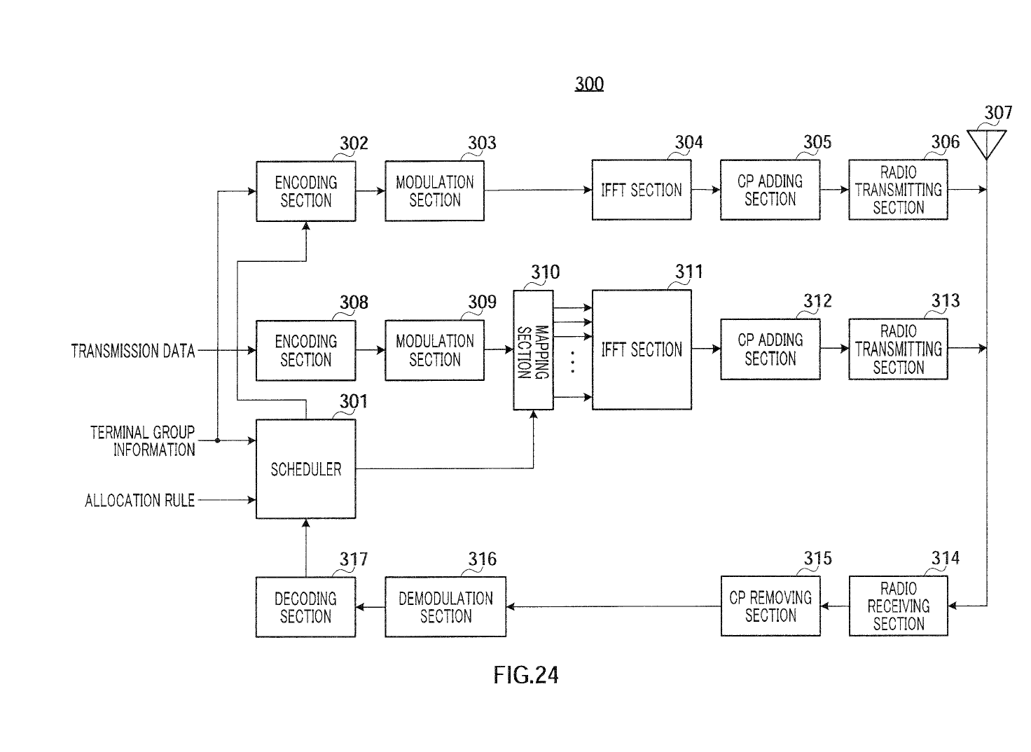

FIG. 24 shows a configuration of base station 300 according to the present embodiment.

In base station 300, terminal group information, showing which terminal belongs to which group, is inputted to scheduler 301 and encoding section 302.

The terminal group information is encoded in encoding section 302, modulated in modulation section 303, subjected to the IFFT in IFFT section 304, added a CP in CP adding section 305, subjected to transmission processing such as D/A conversion, amplification and up-conversion in radio transmitting section 306 and transmitted as a control signal from antenna 307 to each terminal. Transmission of this terminal group information is performed at such times as initial signaling to each terminal and change of terminal group information.

Scheduler 301 performs scheduling for every subframe whereby a plurality of RB's on the frequency domain are allocated to terminals belonging to the first group and terminals belonging to the second group. In this case, scheduler 301 allocates RB's terminals belonging to the first group based on FSA according to the channel quality for each terminal and each RB, and then performs scheduling to allocate remaining RB's other than the RB's allocated to terminals belonging to the first group, to terminals belonging to the second group according to predetermined allocation rules. That is, scheduler 301 performs RB allocation to terminals belonging to the first group preferentially over RB allocation to terminals belonging to the second group. Scheduler 301 then outputs the result of scheduling for terminals belonging to the first group, that is, FSA result, to encoding section 302 and mapping section 310 every time FSA is performed (that is, on a per subframe basis), whereas scheduler 301 does not output the result of scheduling for terminals belonging to the second group. The scheduling result here is an expression of RB's allocated to the individual terminals by RB numbers.

Furthermore, when a terminal that newly starts communication with the base station is a terminal belonging to the second group or a terminal in communication is changed from the first group to the second group, scheduler 301 outputs sequential order information to encoding section 302 and mapping section 310 as initial information for the terminal.

The sequential order information is encoded in encoding section 302, modulated in modulation section 303, subjected to the IFFT in IFFT section 304, added a CP in CP adding section 305, subjected to transmission processing such as D/A conversion, amplification and up-conversion in radio transmitting section 306 and transmitted as a control signal from antenna 307 at the time of initial signaling to terminals belonging to the second group.

Furthermore, the FSA result is encoded in encoding section 302, modulated in modulation section 303, subjected to the IFFT in IFFT section 304, added a CP in CP adding section 305, subjected to transmission processing such as D/A conversion, amplification and up-conversion in radio transmitting section 306 and transmitted as a control signal from antenna 307, to both terminals belonging to the first group and terminals belonging to the second group. On the other hand, since scheduler 301 does not output the scheduling result to terminals belonging to the second group, radio transmitting section 306 does not transmit the scheduling result for the terminals belonging to the second group.

Transmission data is encoded in encoding section 308, modulated in modulation section 309, mapped by mapping section 310 to RB's determined by scheduler 301, subjected to the IFFT in IFFT section 311, added a CP in CP adding section 312, subjected to transmission processing such as D/A conversion, amplification and up-conversion in radio transmitting section 313 and transmitted from antenna 307 to each terminal.

Radio receiving section 314 performs receiving processing such as down-conversion and A/D conversion to a control signal received from each terminal via antenna 307, and outputs the control signal to CP removing section 315. The control signal includes received quality information about each terminal as downlink channel quality information.

CP removing section 315 removes a CP added to the control signal and outputs the control signal after the removal of the CP, to demodulation section 316.

Demodulation section 316 performs equalization processing and other processings for the control signal and then demodulates the control signal, and decoding section 317 decodes the demodulated control signal and outputs the control signal to scheduler 301. The downlink channel quality information included in the control signal is used for scheduling processing in scheduler 301.

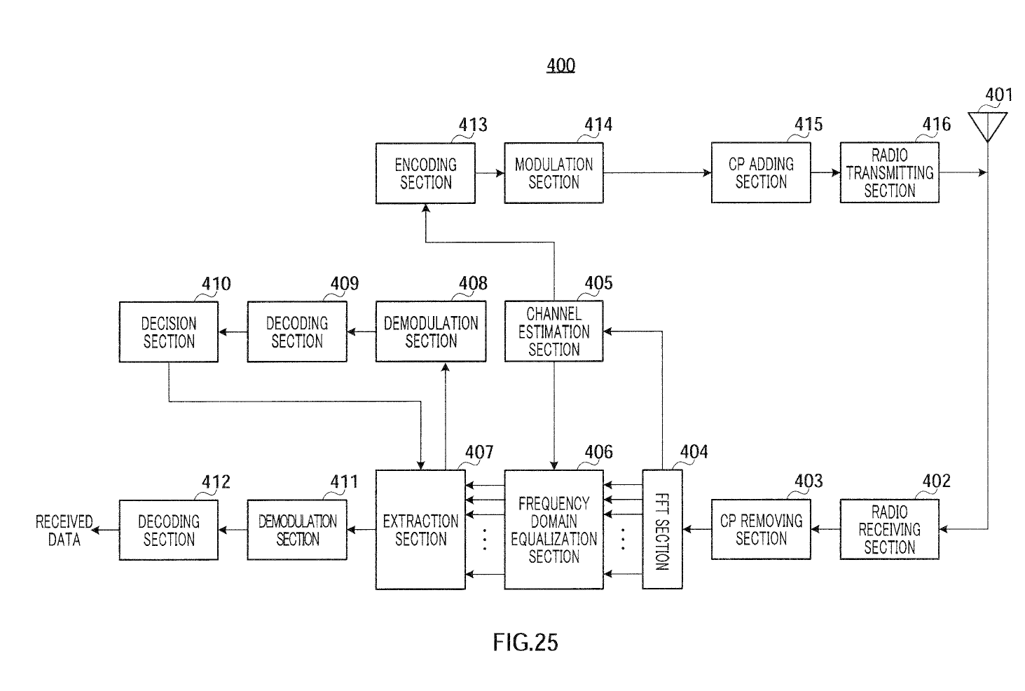

Next, FIG. 25 shows a configuration of terminal 400 according to the present embodiment that can communicate with base station 300.

In terminal 400, radio receiving section 402 performs receiving processing such as down-conversion and A/D conversion to a signal (including the data signal, pilot symbol, terminal group information, sequential order information, FSA result, etc.) received from base station 300 via antenna 401, and outputs the signal to CP removing section 403.

CP removing section 403 removes a CP added to the received signal and outputs the signal after the removal of the CP, to FFT section 404.

FFT section 404 performs an FFT with the received signal, to convert the received signal from the time domain to the frequency domain, outputs pilot symbols to channel estimation section 405 and outputs the signals other than the pilot symbols (including the data signal, terminal group information, sequential order information, FSA result, etc.) to frequency domain equalization section 406.

Channel estimation section 405 estimates the received quality and channel variation of each downlink RB using the pilot symbols converted to the frequency domain and generates received quality information showing received quality of each RB and channel variation information showing a channel variation. The received quality information is outputted to encoding section 413 to be reported to base station 300 and the channel variation information is outputted to frequency domain equalization section 406 to be used in frequency domain equalization.

The received quality information is encoded in encoding section 413, modulated in modulation section 414, added a CP in CP adding section 415, subjected to transmission processing such as D/A conversion, amplification and up-conversion in radio transmitting section 416 and transmitted from antenna 401 to base station 300.

Frequency domain equalization section 406 performs frequency domain equalization to the signal inputted from FFT section 404 using the channel variation information inputted from channel estimation section 405, and outputs the signal after the frequency domain equalization to extraction section 407.

Extraction section 407 extracts a control signal (terminal group information, sequential order information, FSA result, etc.) from the inputted signal and outputs the control signal to demodulation section 408. The control signal is demodulated by demodulation section 408, decoded by decoding section 409 and inputted to decision section 410. Furthermore, extraction section 407 extracts a data signal directed to its own terminal from the inputted signal according to the decision result in decision section 410 and outputs the data signal to demodulation section 411. The data signal is demodulated by demodulation section 411, decoded by decoding section 412 and therefore received data is obtained.

When the terminal group information shows that the terminal belongs to the first group, decision section 410 decides the RB allocated to its own terminal based on the FSA result and outputs the decision result to extraction section 407.

On the other hand, when the terminal group information shows that the terminal belongs to the second group, decision section 410 decides the RB allocated to its own terminal based on the sequential order information, FSA result and preset allocation rule and outputs the decision result to extraction section 407. When the terminal belongs to the second group, decision section 410 identifies RB's other than the RB's allocated to terminals belonging to the first group as candidates of the RB allocated to its own terminal from the FSA result. Decision section 410 then decides the RB allocated to its own terminal out of the RB's identified as the candidates according to the sequential order information and allocation rule.

Next, differences between a case where the present invention is applied to uplink RB allocation (that is, uplink data transmission) and a case where the present invention is applied to downlink RB allocation (that is, downlink data transmission) will be explained.

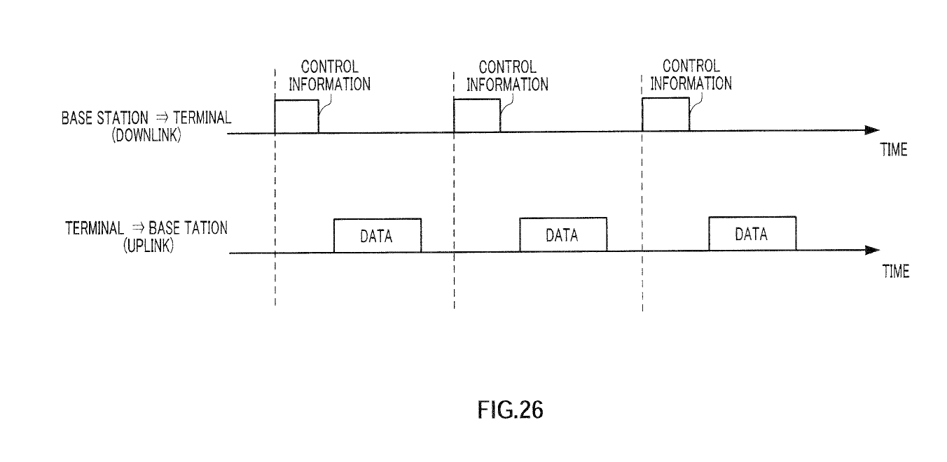

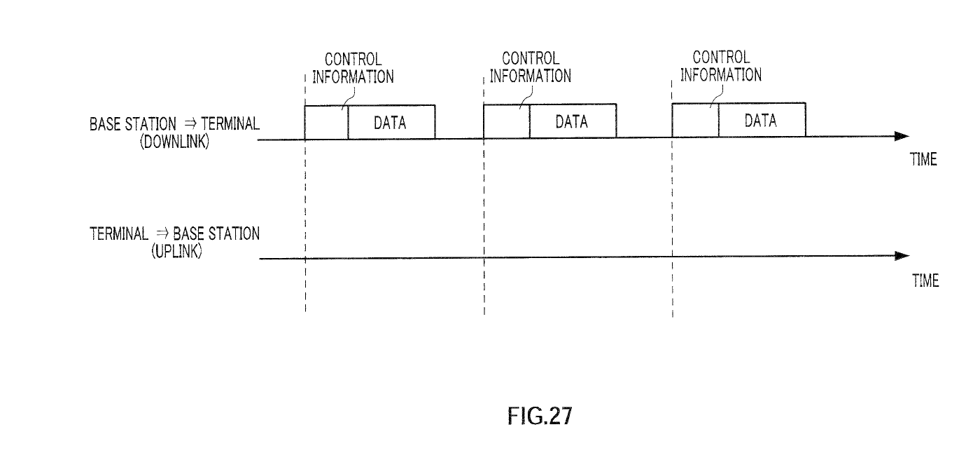

In both cases where the present invention is applied to uplink RB allocation (FIG. 26) and where the present invention is applied to downlink RB allocation (FIG. 27), control information is reported from the base station to the terminals.

However, in the case where the present invention is applied to uplink RB allocation, the terminal receives control information, decides the RB's to transmit uplink data based on the control information, maps uplink data to the RB's according to the decision result and transmits the uplink data to the base station (FIG. 26).

On the other hand, in the case where the present invention is applied to downlink RB allocation, the terminal receives control information and downlink data, decides the RB allocated to the terminal based on the control information and extracts the data directed to the terminal from the downlink data according to the decision result (FIG. 27).

In this way, according to the present embodiment, it is possible to provide operations and effects of downlink RB allocation similar to those of Embodiment 1.

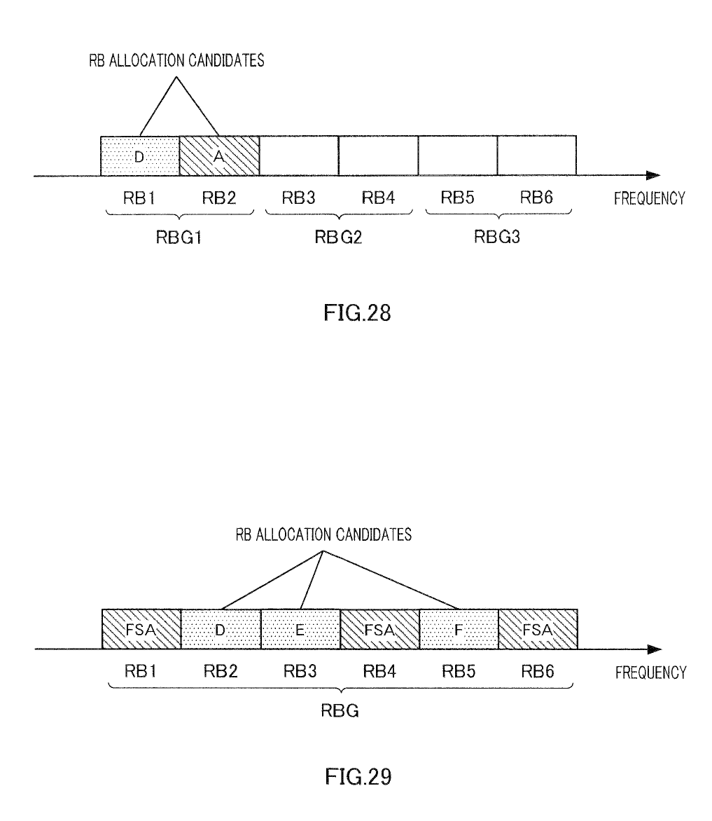

When the allocation rule of dividing a plurality of RB's into a plurality of RBG's as in the case of Embodiment 3 is used, a terminal belonging to the second group may perform demodulation and decoding for all the RB's in the RBG with which its own terminal is associated, and decide an RB free of errors as the RB for the terminal. More specifically, as shown in FIG. 28, when terminal D belonging to the second group is associated with RBG 1 and RB allocation candidates of terminal D are RB 1 and RB 2, terminal D demodulates and decodes received data of both RB 1 and RB 2 and decides an RB free of errors as the RB for terminal D. For example, the allocated RB is decided through error detection using the CRC (Cyclic Redundancy Check) code, which varies between terminals. When such error detection is performed, data directed to the subject terminal becomes error-free, while data directed to other terminals contains errors, and therefore it is possible to accurately decide the RB allocated to the subject terminal. In FIG. 28, terminal D checks the presence/absence of errors with received data through such error detection, and, when no error is detected in the received data of RB 1 and an error is detected in the received data of RB 2, terminal D can decide that RB 1 is allocated to terminal D. In this way, by dividing a plurality of RB's into a plurality of RBG's in the downlink and allocating the RB's to individual terminals, a terminal belonging to the second group can decide the RB allocated to the terminal by demodulating and decoding only the received data in the RB's in the RBG with which the terminal is associated, without demodulating and decoding all RB's.

Furthermore, when a terminal belonging to the second group does not receive any report of sequential order information or cannot accurately demodulate and decode sequential order information, the terminal belonging to the second group performs demodulation and decoding for all the RB's that may be allocated to the terminal based on an FSA result and may decide an RB that is free of errors as the RB for the terminal. More specifically, in an RBG made up of RB's 1 to 6 as shown in FIG. 29, suppose a terminal belonging to the second group regards RB 2, RB 3 and RB 5 other than RB 1, RB 4 and RB 6 allocated to terminals belonging to the first group as candidates for RB allocation based on the FSA result. Since a terminal belonging to the second group has no sequential order information, the terminals does not know which of RB 2, RB 3 and RB 5 is allocated to the terminal. Therefore, a terminal belonging to the second group demodulates and decodes the received data of RB 2, RB 3 and RB 5, and decides an RB free of errors as the RB for the terminal. For example, the RB to be allocated is decided through error detection using the CRC code which varies between terminals as described above. In this way, by using a plurality of RB's in the downlink to make up an RBG, even when the sequential order information for terminals belonging to the second group is not reported and accurate demodulation and decoding are not possible, a terminal belonging to the second group can decide the RB allocated to the terminals by demodulating and decoding only the candidates of allocated RB's in the RBG associated with the terminal from the FSA result without demodulating and decoding all RB's.

Furthermore, the method of detecting an error in received data for deciding the RB allocated to the terminal is not limited to the one using CRC code, but any method can be used that makes it possible to decide only data directed to the terminal as data free of errors and data directed to other terminals as data containing errors.

### Embodiment 8

According to synchronous HARQ (Hybrid Automatic Repeat reQuest), an RB to which retransmission data is allocated is determined when a terminal feeds back a NACK (Negative ACKnowledgment) to the base station, and therefore synchronous HARQ is suitable for terminals belonging to the second group. Therefore, the present embodiment will explain a case where the present invention adopts synchronous HARQ.

Suppose synchronous HARQ here carries out the first data transmission in subframe n and a retransmission of the data in subframe n+3. Furthermore, suppose RB 2 and RB 3 make up an RBG.

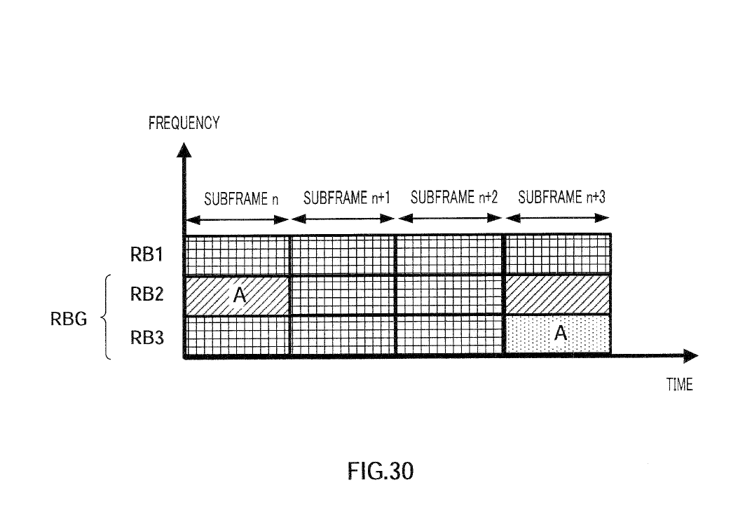

As shown in FIG. 30, terminal A to which RB 2 is allocated in subframe n feeds back a NACK to the base station because the first transmission data contains an error. In subframe n, suppose terminal A belongs to the first group.

The base station having received a NACK from terminal A updates terminal group information to change terminal A from the first group to the second group. However, the base station does not transmit updated terminal group information to terminal A. This is because the terminal which has fed back a NACK knows that it will be switched to the second group having fed back a NACK.

In subframe n+3, the base station performs RB allocation to terminal A belonging to the second group and transmits retransmission data to terminal A. In this case, the base station allocates one of RB 2 and RB 3 making up the RBG to a terminal belonging to the first group and allocates the other to terminal A. FIG. 30 shows a case where RB 3 is allocated to terminal A.

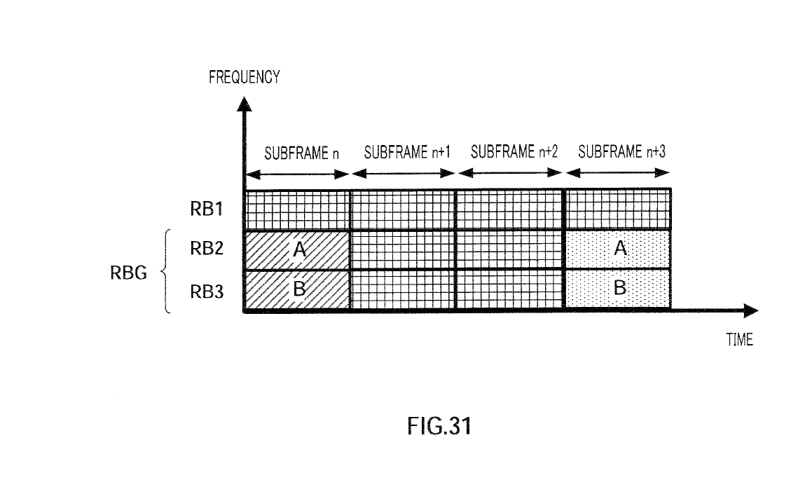

Furthermore, as shown in FIG. 31, when both terminal A to which RB 2 is allocated and terminal B to which RB 3 is allocated feed back a NACK to the base station in subframe n, the base station having received a NACK updates terminal group information to change both terminal A and terminal B from the first group to the second group. However, the base station does not transmit updated terminal group information to terminal A and terminal B. In subframe n, suppose terminal A and terminal B belong to the first group.

In subframe n+3, the base performs RB allocation to terminal A and terminal B belonging to the second group, and transmits retransmission data to terminal A and terminal B. In this case, the base station allocates one of RB 2 and RB 3 making up the RBG to terminal A and allocates the other to terminal B, based on an allocation rule. When there is no RB allocated to terminals belonging to the first group in the RBG, since it is possible to assume that both terminal A and terminal B may have fed back a NACK, it is preferable to employ an allocation rule that the same RB allocated in subframe n is allocated to each terminal in subframe n+3. This allocation rule can prevent collision of retransmission data in subframe n+3. FIG. 31 shows a case where RB 2 is allocated to terminal A and RB 3 is allocated to terminal B according to this allocation rule.

A case where the present invention adopts synchronous HARQ has been explained so far.

In subframe n, terminal A and terminal B may also belong to the second group.

Furthermore, when an RBG is made up of three or more RB's and there are two or more terminals that feed back a NACK, sequential order information needs to be reported to the destination terminal of retransmission data. For example, when RB's 1, 2 and 3 are allocated to terminals A, B and C in subframe n and retransmission is performed to terminals A and B in subframe n+3, it is not reported to terminal B whether the retransmission to terminal A is retransmission to terminal A or to terminal C. Therefore, in such a case, sequential order information needs to be reported to terminal B.

Furthermore, since there is a possibility that the destination terminal of retransmission data may leave the second group after receiving the retransmission data, sequential order information of a higher number is reported to the destination terminal of retransmission data, so that the sequential order information need not be updated in such a case either. When, for example, a terminal subject to the initial transmission is performed and a terminal subject to a retransmission is performed are newly added to the second group and the sequential order information already used is sequential order information #1 to #3, sequential order information #4 may be allocated to the terminal of the initial transmission destination and sequential order information #5 may be allocated to the terminal of the retransmission destination.

Furthermore, though the present embodiment has explained a case assuming downlink synchronous HARQ, the present invention is also applicable to uplink synchronous HARQ in the same way as described above.

### Embodiment 9

As opposed to the above-described embodiments where a plurality of RB's in the frequency domain are divided into a plurality of RBG's, the present embodiment divides a plurality of RB's in the frequency domain and in the time domain into a plurality of RBG's.

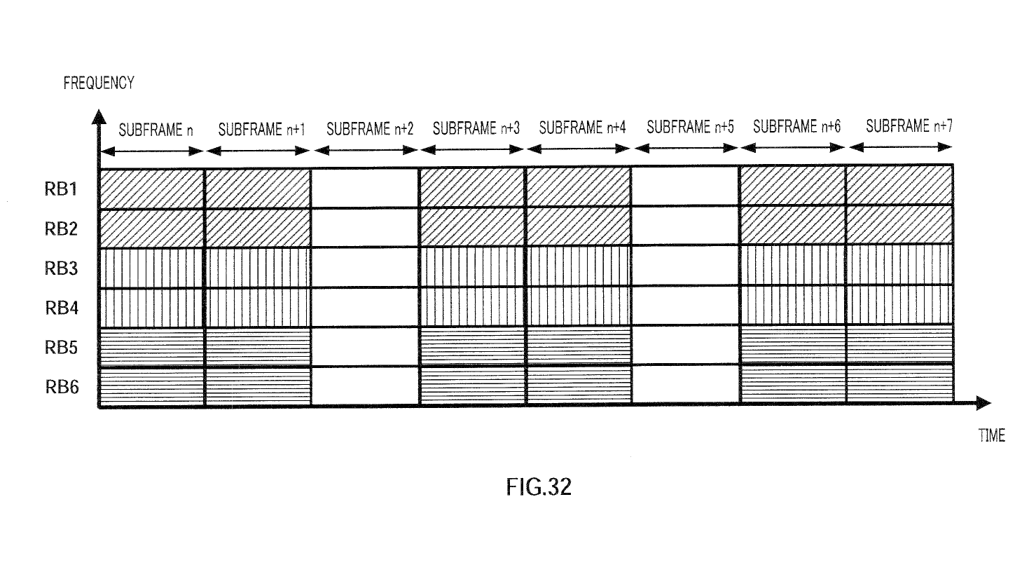

In the following explanations, as shown in FIG. 32, one RBG is made up of four RB's ranging over the frequency domain and time domain. More specifically, in FIG. 32, RBG 1 is made up of RB 1 and RB 2 in subframe n and RB 1 and RB 2 in subframe n+1, RBG 2 is made up of RB 3 and RB 4 in subframe n and RB 3 and RB 4 in subframe n+1, and RBG 3 is made up of RB 5 and RB 6 in subframe n and RB 5 and RB 6 in subframe n+1. Likewise, in subframe n+3 and subframe n+4, RB's 1 to 6 are divided into three RBG's of RBG's 1 to 3, and in subframe n+6 and subframe n+7, RB's 1 to 6 are divided into three RBG's of RBG's 1 to 3.

Here, suppose RB's 1 to 6 need to be allocated to terminals belonging to the first group in subframe n as an example. Furthermore, suppose the number of terminals belonging to the second group is three and the three terminals belonging to the second group are each associated with one of RBG's 1 to 3 according to an allocation rule.

In subframe n, scheduler 101 (FIG. 1) performs FSA targeting all RBG's 1 to 3 (that is, all of RB's 1 to 6). Scheduler 101 allocates one of RB's 1 to 6 to each terminal belonging to the first group in descending order of priority in view of QoS (Quality of Service).

Next, scheduler 101 expands the RBG's to subframe n+1. In subframe n+1, scheduler 101 allocates one of RB's 1 to 6 to each of the three terminals belonging to the first group and three terminals belonging to the second group. As in the case of Embodiment 3, scheduler 101 allocates one RB of one RBG to a terminal belonging to the first group and then allocates the other RB of the same RBG to a terminal belonging to the second group, based on the associations according to the allocation rule.

Here, the FSA result is transmitted to all terminals on a per subframe basis, whereas the scheduling result for a terminal belonging to the second group is not transmitted. However, a terminals belonging to the second group can decide the RB allocated to the terminal from the FSA result based on the allocation rule.

More specifically, a terminal belonging to the second group, upon being reported that the both RB's of the RBG allocated to the terminal in subframe n are allocated to a terminal belonging to the first group, is able to decide that the RBG is expanded in the time domain. In subframe n+1, decision section 206 (FIG. 2) decides that the remaining RB's other than the RB's allocated to terminals belonging to the first group, as the RB's allocated to the terminal, from the FSA result based on the allocation rule.

In this way, in accordance with the present embodiment, when there are many terminals that belong to the first group subject to FSA, an RBG is made up of RB's of a plurality of subframes, that is, the RBG is expanded in the time domain and is made up of a plurality of RB's in the frequency domain and in the time domain, so that the range of RB allocation to terminals belonging to the second group expands and the flexibility of RB allocation to terminals belonging to the first group improves.

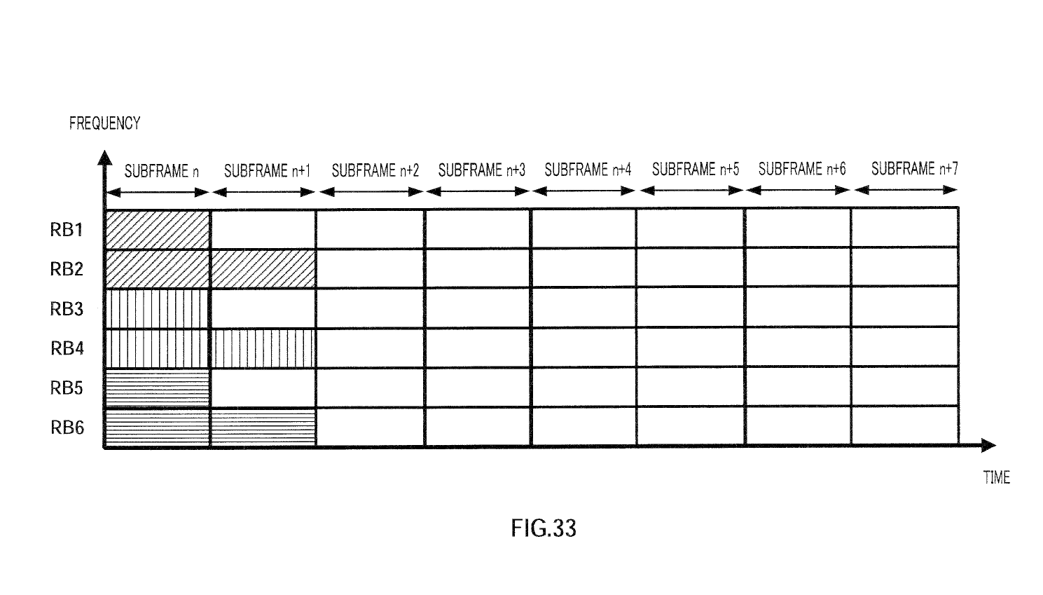

In the above explanations, the RBG (FIG. 32) made up of four RB's has been taken as an example, but the RBG configuration is not limited to this. For example, as shown in FIG. 33, an RBG may also be made up of a plurality of RB's that form an L-shape in the frequency and time domains. More specifically, RBG 1 is made up of three RB's, namely RB 1 and RB 2 in subframe n and RB 2 in subframe n+1; RBG 2 is made up of three RB's, namely RB 3 and RB 4 in subframe n and RB 4 in subframe n+1; and RBG 3 is made up of three RB's, namely RB 5 and RB 6 in subframe n and RB 6 in subframe n+1.

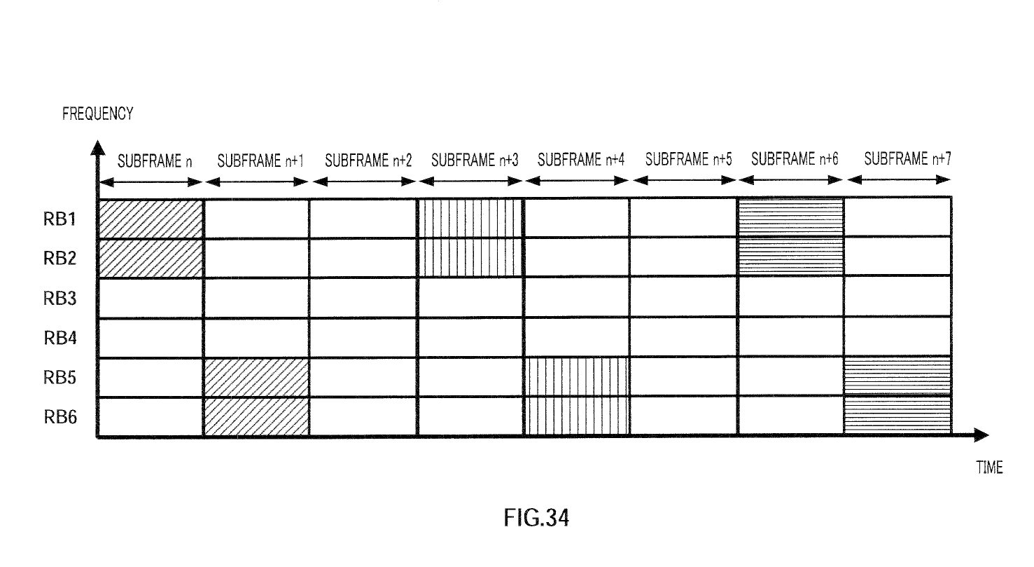

Furthermore, as shown in FIG. 34, an RBG may also be made up of RB's in different subframes. More specifically, RBG 1 is made up of four RB's, namely RB 1 and RB 2 in subframe n and RB 5 and RB 6 in subframe n+1; RBG 2 is made up of four RB's, namely RB 1 and RB 2 in subframe n+3 and RB 5 and RB 6 in subframe n+4; and RBG 3 is made up of four RB's, namely RB 1 and RB 2 in subframe n+6 and RB 5 and RB 6 in subframe n+7.

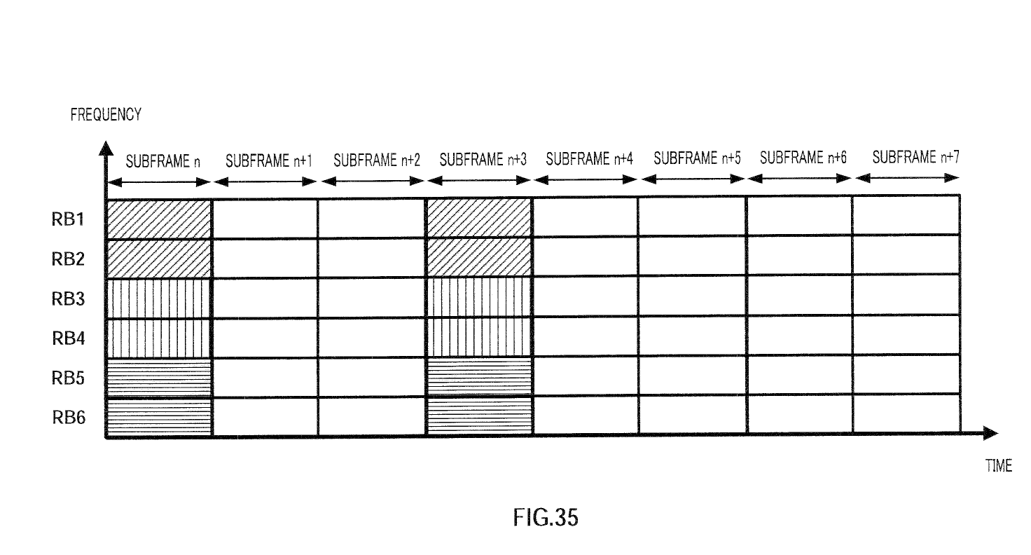

Furthermore, as shown in FIG. 35, time intervals (i.e. subframe intervals) may be provided between RB's making up an RBG. More specifically, RBG 1 is made up of four RB's, namely RB 1 and RB 2 in subframe n and RB 1 and RB 2 in subframe n+3; RBG 2 is made up of four RB's, namely RB 3 and RB 4 in subframe n and RB 3 and RB 4 in subframe n+3; and RBG 3 is made up of four RB's, namely RB 5 and RB 6 in subframe n and RB 5 and RB 6 in subframe n+3.

Furthermore, the present embodiment has explained a case where terminals belonging to the first group are allocated to all RBG's 1 to 3 (that is, all of RB's 1 to 6) in subframe n as an example, but, when only one of the two RB's of each RBG in subframe n is allocated to a terminal belonging to the first group, scheduler 101 allocates the other RB to a terminal belonging to the second group, based on the association according to the allocation rule. That is, the RBG need not be expanded in the time domain in this case.

Furthermore, the present embodiment has explained uplink RB allocation, but the present invention can be likewise applied to downlink RB allocation.

Furthermore, the present embodiment has explained a case where an RBG is expanded in the time domain by only one subframe, but the number of subframes by which the RBG is expanded can be two or more. When, for example, an RBG is expanded to subframe n+1, if RB's are not allocated to terminals belonging to the second group, scheduler 101 may further expand the RBG to subframe n+2.

### Embodiment 10

The present embodiment will set the received quality of terminals belonging to the second group to a level equal to or higher than a threshold for each of a plurality of RBG's.

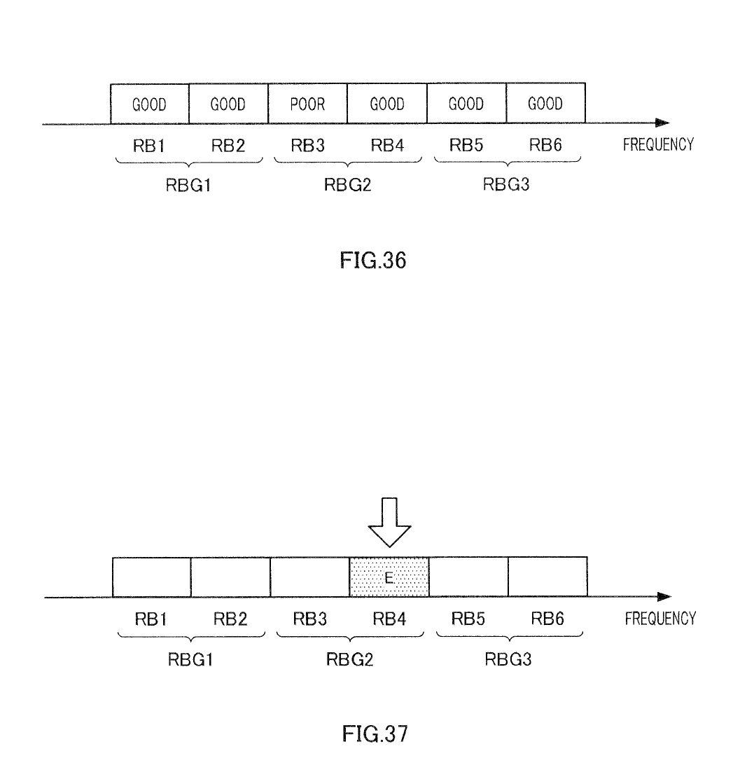

Scheduler 101 (FIG. 1) will perform the following scheduling. Here, as shown in FIG. 36, a case where RB's 1 to 6 are divided into three RBG's 1 to 3 will be explained. Furthermore, suppose terminals A to C belong to the first group and terminals D to F belong to the second group. Furthermore, suppose FSA is performed per subframe. The allocation rule according to the present embodiment defines the associations of a plurality of RBG's with terminals belonging to the second group over a plurality of subframes and according to this allocation rule, RBG 1 (RB's 1 and 2) is associated with terminal D, RBG 2 (RB's 3 and 4) with terminal E and RBG 3 (RB's 5 and 6) with terminal F.

First, scheduler 101 obtains received quality information about each RB in an RBG with which each terminal belonging to the second group is associated. As shown in FIG. 36, scheduler 101 obtains received quality information showing whether the received quality of each RB in an RBG at each terminal belonging to the second group is equal to or higher than a threshold or lower than the threshold. Here, suppose received quality information showing that received quality is equal to or higher than the threshold is “good” and received quality information showing that received quality is lower than the threshold is “poor.” More specifically, the received quality information for RB 1 and RB 2 at terminal D associated with RBG 1 is “good,” the received quality information for RB 3 at terminal E associated with RBG 2 is “poor,” the received quality information for RB 4 is “good” and the received quality information for RB 5 and RB 6 at terminal F associated with RBG 3 is “good.”

Here, to place the focus on RBG 1, the received quality information for terminal D is “good” for both RB 1 and RB 2 of terminal D associated with RBG 1. That is to say, received quality is equal to or higher than the threshold no matter which of RB 1 or RB 2 is allocated to terminal D. Likewise, received quality is equal to or higher than the threshold no matter which of RB 5 or RB 6 is allocated to terminal F.

On the other hand, when to place the focus on RBG 2, the received quality information for RB 3 at terminal E associated with RBG 2 is “poor” and the received quality information at RB 4 is “good.” That is, if RB 3 is allocated to terminal E, the received quality falls short of the threshold and terminal E cannot receive data correctly.

Therefore, as shown in FIG. 37, scheduler 101 allocates RB's 4 to terminal E before performing FSA for terminals belonging to the first group in RBG 2. After allocating RB 4 of RBG 2 to terminal E, scheduler 101 allocates one RB in each RBG to each of the terminals belonging to the first group as in the case of Embodiment 3 and then allocates the other RB to each of the terminals belonging to the second group based on the associations according to the allocation rule. However, since RB 4 has already been allocated to terminal E in RBG 2, allocation to the terminal belonging to the second group is not performed.

Here, since received quality of terminal D of RBG 1 and terminal F of RBG 3 is equal to or higher than the threshold with all RB's in the associated RBG's, even when scheduler 101 allocates one RB to a terminal belonging to the first group and then allocates the other RB to a terminal belonging to the second group based on the allocation rule, it is possible to secure good received quality.

In this way, according to the present embodiment, it is possible to improve the frequency scheduling effect of terminals belonging to the first group while maintaining the received quality of terminals belonging to the second group.

The received quality information reported by a terminal belonging to the second group to the base station may be only the received quality information for RB's in the RBG associated with the terminal.

Furthermore, the received quality information reported from each terminal to the base station may be made up of one bit representing either “good” or “poor.”

Furthermore, when the received quality of terminals belonging to the second group is lower than a threshold with all RB's in an RBG, scheduler 101 may allocate RB's of better received quality to terminals belonging to the second group. Alternatively, as in the case of Embodiment 3, scheduler 101 may allocate RB's to terminals belonging to the first group preferentially and allocate remaining RB's other than the RB's allocated to terminals belonging to the first group, to terminals belonging to the second group.

Furthermore, the present embodiment has explained uplink RB allocation, but the present embodiment can be likewise applied to downlink RB allocation.

Embodiments of the present invention have been explained so far.

In the above-described embodiments, when terminals communicating with base station 100 are distinguished between terminals located at cell edges and other terminals (that is, terminals not located at cell edges), it is preferable to regard the terminals not located at cell edges as terminals belonging to the second group and perform RB allocation to the terminals not located at cell edges according to an allocation rule. In the above-described embodiments, each terminal belonging to the first group only needs to be able to receive the FSA result of the terminal, whereas each terminal belonging to the second group needs the FSA results of all terminals belonging to the first group, so that and it is preferable to regard terminals located relatively near base station 100, that is, terminals not located at cell edges as terminals belonging to the second group.

Furthermore, in the above-described embodiments, terminals communicating with base station 100 can be distinguished between terminals carrying out speech communication and terminals carrying out other communication, it is preferable to regard terminals carrying out speech communication as terminals belonging to the second group and perform RB allocation to the terminals carrying out speech communication according to the allocation rule. Terminals carrying out speech communication have a small amount of transmission data and are not required to have so a high error rate performance and therefore need not particularly provide substantial multiuser diversity effect through FSA.

Furthermore, in the above-described embodiments, the present invention may only be applied to specific frequency bands out of frequency bands available to the communication system. For example, the present invention may only be applied to specific frequency bands dedicated to terminals located at cell edges. The base station transmits data to terminals located at cell edges with large transmission power in view of the influence of propagation attenuation (i.e. path loss). Therefore, even when terminals belonging to the second group are located at cell edges, the possibility that terminals belonging to the second group may not be able to acquire the FSA result decreases.

Furthermore, the above-described embodiments have explained cases where the number of RB's making up each RBG is two, three or four, but the number of RB's making up each RBG is not limited to these numbers.

Furthermore, as described above, the present invention is applicable to both uplink RB allocation and downlink RB allocation.

Instead of the FFT and IFFT, the DFT (Discrete Fourier Transform) and IDFT (Inverse Discrete Fourier Transform) may also be used. Furthermore, the time-frequency domain conversion and frequency-time domain conversion methods are not limited to the FFT, DFT, IFFT and IDFT.

Furthermore, terminal 200 may also be configured without using time-frequency domain conversion and frequency-time domain conversion such as the FFT and IFFT. For example, if radio transmitting section 218 transmits pilot symbols and data symbols by changing transmission bands according to the mapping results at mapping section 208 and mapping section 214, terminal 200 need not be provided with FFT section 207, IFFT section 209, FFT section 213 and IFFT section 215.

Furthermore, the subframes used in the above explanations may also be other transmission time units such as time slots and frames.

The CP used in the above explanations may also be called a “guard interval (GI).” Furthermore, subcarriers may also be called “tones.” Furthermore, a base station may be expressed as “Node B,” and a terminal may be expressed as a “mobile station” or “UE.”

Furthermore, a plurality of RB's making up an RBG need not be neighboring RB's.

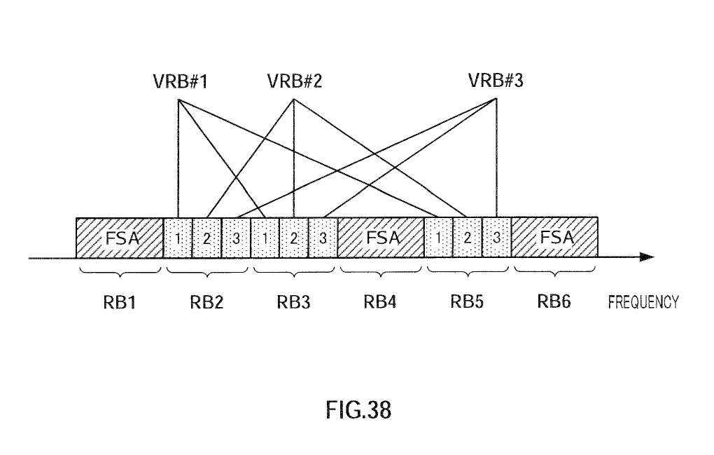

Furthermore, as shown in FIG. 38, it is also possible to divide each of the remaining RB's according to the number of the remaining RB's, combining their corresponding parts and defining the combinations as VRB's (Virtual Resource Blocks). In the example shown in FIG. 38, there are three remaining RB's, namely RB's 2, 3 and 5, and therefore RB's 2, 3 and 5 are each divided into three parts, to combine the first parts of the RB's and make VRB #1, combine the second parts of the RB's and make VRB #2 and combine the third parts of the RB's to make VRB #3. RB allocation to terminals belonging to the second group is performed in VRB units. This causes data of each terminal belonging to the second group to be distributed and mapped on the frequency domain and therefore improves the frequency diversity effect.

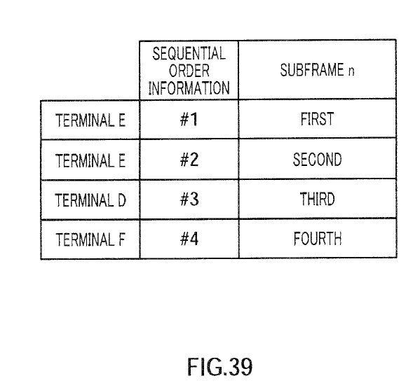

Furthermore, as shown in FIG. 39, a plurality of pieces of sequential order information can also be allocated to one terminal. In the example shown in FIG. 39, sequential order information #1 and #2 are assigned to terminal E. Terminal E is, for example, a terminal containing a large amount of data.

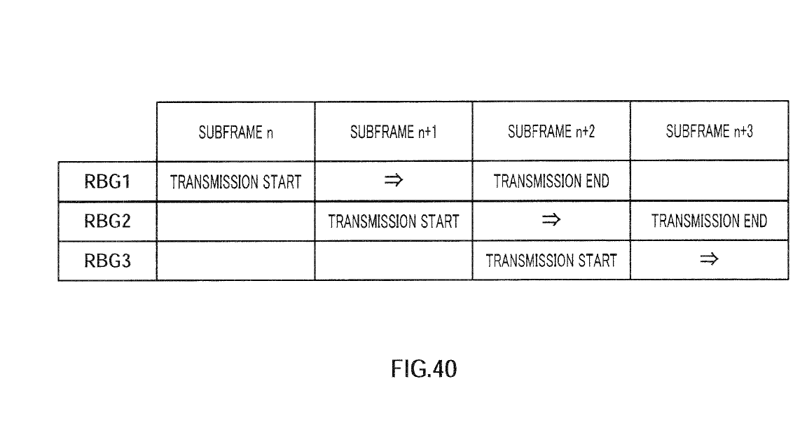

Furthermore, as shown in FIG. 40, transmission start timing may be made to vary between RBG's. In the example shown in FIG. 40, the transmission start timing for REG 1 is set to subframe n, the transmission start timing for RBG 2 is set to subframe n+1 and the transmission start timing for RBG 3 is set to subframe n+2, so that the transmission start timing for one RBG is shifted one frame from another RBG. This allows the timing for signaling control information carried out at the start of transmission to vary between RBG's, so that, as a result, it is possible to distribute signaling of control information over individual subframes and prevent signaling of control information from concentrating in the same subframes. Furthermore, it is possible to increase opportunities to start transmission.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC”, “system LSI”, “super LSI”, or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2006-164870, filed on Jun. 14, 2006, Japanese Patent Application No. 2006-216150, filed on Aug. 8, 2006, and Japanese Patent Application No. 2007-003662, filed on Jan. 11, 2007, including the specifications, drawings and abstracts, are incorporated herein by reference in their entirety.

### INDUSTRIAL APPLICABILITY

The present invention is applicable to, for example, mobile communication systems.

1-15. (canceled)

16. A radio communication base station apparatus for allocating a plurality of resource blocks in a frequency domain to a plurality of radio communication terminals classified into a first group and second group, the radio communication base station apparatus comprising:
a first scheduling section that allocates resource blocks to the radio communication terminals belonging to the first group based on first scheduling according to channel quality; and
a second scheduling section that performs second scheduling to allocate remaining resource blocks other than the resource blocks allocated to the radio communication terminals belonging to the first group, to the radio communication terminals belonging to the second group according to a predetermined allocation rule.

17. The radio communication base station apparatus according to claim 16, further comprising a transmitting section that transmits a result of the first scheduling to both the radio communication terminals belonging to the first group and the radio communication terminals belonging to the second group but does not transmit a result of the second scheduling.

18. The radio communication base station apparatus according to claim 16, wherein the allocation rule defines a sequential order of the remaining resource blocks of the radio communication terminals belonging to the second group over a plurality of subframes.

19. The radio communication base station apparatus according to claim 18, wherein the scheduling section allocates the remaining resource blocks to the radio communication terminals belonging to the second group according to the sequential order.

20. The radio communication base station apparatus according to claim 18, wherein, with the allocation rule, the sequential order changes over time.

21. A radio communication base station apparatus for allocating a plurality of resource blocks in a frequency domain to a plurality of radio communication terminals classified into a first group and second group, the plurality of resource blocks being divided into a plurality of resource block groups, the radio communication base station apparatus comprising:
a first scheduling section that allocates resource blocks to the radio communication terminals belonging to the first group using each resource block group as a unit, based on first scheduling according to channel quality; and
a second scheduling section that performs second scheduling to allocate remaining resource blocks other than the resource blocks allocated to the radio communication terminals belonging to the first group, to the radio communication terminals belonging to the second group using each resource block group as a unit, according to a predetermined allocation rule.

22. The radio communication base station apparatus according to claim 21, further comprising a transmitting section that transmits a result of the first scheduling to both the radio communication terminals belonging to the first group and the radio communication terminals belonging to the second group but does not transmit a result of the second scheduling.

23. The radio communication base station apparatus according to claim 21, wherein the allocation rule defines associations between the plurality of resource block groups with the radio communication terminals belonging to the second group over a plurality of subframes.

24. The radio communication base station apparatus according to claim 23, wherein the scheduling section allocates the remaining resource blocks to the radio communication terminals belonging to the second group based on the association.

25. The radio communication base station apparatus according to claim 21, wherein:
the plurality of resource block groups each comprise two resource blocks; and
according to the allocation rule, one radio communication terminal belonging to the second group is associated with one resource block group.

26. The radio communication base station apparatus according to claim 25, wherein the scheduling section allocates one resource block to a radio communication terminal belonging to the first group and then allocates the other resource block to a radio communication terminal belonging to the second group based on the association, in each of the plurality of resource block groups.

27. The radio communication base station apparatus according to claim 23, wherein, in the allocation rule, the association changes over time.

28. The radio communication base station apparatus according to claim 21, wherein, according to the allocation rule, resource blocks making up each resource block group changes over time.

29. The radio communication base station apparatus according to claim 21, wherein the radio communication terminals belonging to the second group comprise radio communication terminals that carry out speech communication.

30. A radio communication terminal apparatus comprising:
a receiving section that receives the result of the first scheduling from the radio communication base station apparatus according to claim 16; and
a decision section that, when the radio communication terminal apparatus belongs to the second group, decides a resource block allocated to the radio communication terminal apparatus based on the allocation rule and the result of the first scheduling received.

31. The radio communication terminal apparatus according to claim 30, wherein the decision section regards resource blocks other than the resource blocks allocated to the radio communication terminals belonging to the first group, as candidates of a resource block allocated to the radio communication terminal apparatus.

32. A resource block allocation method of allocating a plurality of resource blocks in a frequency domain to a plurality of radio communication terminals classified into a first group and second group, the resource block allocation method comprising the steps of:
allocating resource blocks to radio communication terminals belonging to the first group based on first scheduling according to channel quality; and
allocating remaining resource blocks other than the resource blocks allocated to the radio communication terminals belonging to the first group, to the radio communication terminals belonging to the second group according to a predetermined allocation rule.
